(19) United States
(12) Patent Application Publication
(10) Pub. No.: US 2015/0042447 A1
(43) Pub. Date: Feb. 12, 2015

(54) ENTERTAINMENT ENVIRONMENT REMOTE CONTROL AND AUDIO/VIDEO STREAMING METHOD AND SYSTEM

(71) Applicant: FLYOVER INNOVATIONS, LLC, Kansas City, MO (US)

(72) Inventors: Mark VOGT, Kansas City, MO (US); Jason CARMAN, Kansas City, MO (US)

(73) Assignee: FLYOVER INNOVATIONS, LLC, Kansas City, MO (US)

(21) Appl. No.: 14/251,027

(22) Filed: Apr. 11, 2014

Related U.S. Application Data
(63) Continuation-in-part of application No. 14/099,965, filed on Dec. 8, 2013, now abandoned.
Application No. 14/099,965 is a continuation-in-part of application No. 13/964,012, filed on Aug. 9, 2013, now abandoned.

(51) Int. Cl. G08C 23/04

(52) U.S. Cl. CPC G08C 23/04
USPC 340/4.41

(57) ABSTRACT

A remote control and streaming interface for an entertainment environment. The system includes an infrared (IR) transmitter panel holding a plurality of IR LEDs formed in an LED array. The system also includes at least one transceiver configured to maintain a bidirectional administration link with a smart handheld device and configured to maintain a separate streaming link with the smart handheld device. The system includes a processor configured to identify remote control (RC) commands received over the administration link, the processor configured to direct the LED array to generate an IR signal having a select IR pulse sequence based on the RC commands. The system also includes the LED array configured to transmit the IR signal in a reflective-deflective pattern across the entertainment environment until reaching at least one remotely controlled (RC) device within the entertainment environment wherein the RC device is positioned in a non-line of sight relation with the LED array.

### CROSS-REFERENCE TO RELATED APPLICATIONS

This application is a continuation in part of non-provisional U.S. patent application Ser. No. 14/099,965, entitled “METHOD FOR PROXIMITY BASED AUDIO DEVICE SELECTION”, filed Dec. 8, 2013, and is a continuation in part of non-provisional U.S. patent application Ser. No. 13/964,012, entitled “METHOD FOR AUDIO RECEIVER TO SELECT AUDIO SOURCE FROM MULTIPLE TRANSMITTERS”, filed Aug. 9, 2013. Each of the above applications is hereby incorporated by reference in its entirety.

### BACKGROUND OF THE INVENTION

The present disclosure is generally related to proximity based wireless remote control of audio systems. More specifically, the present disclosure relates to an interface to enable smart devices to remotely control and stream audio and video to audio/video devices within an entertainment environment.

In recent years, more and more audio/video devices are being used at various locations in and around homes. This leads to the presence of a multitude of remote control devices in our lives. Remote control devices are becoming more sophisticated with additional capabilities and features. Home audio/video systems are getting more complicated and harder to control. They typically do not have a means to select audio/video devices close to the user.

Modern day hand-held devices are also becoming increasingly powerful. Examples of these smart devices include smart phones, music players, electronic tablets, etc. More specifically, these devices include iOS products like the iPhone™, iPod Touch™ and iPad™ devices (manufactured and sold by Apple Inc.), smart phones and tablets by Blackberry™, Android™ phones and tablets, and touch screen devices by Motorola, Samsung and others. These devices include processors capable of performing multiple tasks and supporting many different “applications”. Some such applications enable these smart hand-held devices to be used as remote control devices. With the increasing use of smart hand-held devices as remote control devices, we are starting to face situations where there are multiple devices for the same remote control. There is a need for a system and interface to identify the nearby controllable devices close to the remote control device. The present disclosure addresses such a need in audio and video systems.

### BRIEF SUMMARY OF THE INVENTION

Embodiments herein concern methods and systems for devices to remotely control and stream audio and/or video signals to nearby audio and/or video devices in a wireless network based audio/video system. The system comprises an infrared (IR) transmitter panel holding a plurality of IR LEDs formed in a LED array and at least one transceiver configured to maintain an administration link with a smart handheld device and configured to maintain a separate streaming link with the smart handheld device. The system also comprises a processor configured to identify remote control (RC) commands received over the administration link, the processor configured to direct the LED array to generate an IR signal having a select IR pulse sequence based on the RC commands. The LED array is configured to transmit the IR signal in a reflective-deflective pattern across the entertainment environment until reaching at least one remotely controlled (RC) device within the entertainment environment, wherein the RC device is positioned in a non-line of sight relation with the LED array.

Optionally, the system may further comprise an audio output component configured to generate an audio signal, the processor configured to identify audio data received over the streaming link, the processor configured to direct the audio output component to generate the audio signal based on the audio data. Alternatively, the system may be configured wherein the IR signals are configured to reflect off objects in the entertainment environment in multiple directions.

Optionally, the system may be configured wherein the IR LEDs are arranged in a two dimensional array on the IR transmitter panel. Alternatively, the system may be configured wherein the LED array includes first and second LEDs having corresponding different first and second propagation directions and different first and second propagation envelopes, respectively. Alternatively, the system may be configured wherein the first propagation envelope has a narrow beamwidth and the second propagation envelope has a wide beamwidth relative to the narrow beamwidth. Optionally, the system may be configured wherein the first and second propagation directions project at different first and second angles from a front surface of the IR transmitter panel such that the first and second IR LEDs transmit IR signals having a common IR code from the IR transmitter panel at the different first and second angles.

Alternatively, the system may be configured wherein the transceiver is configured to establish a temporary low energy administration link between the home unit and at least one smart handheld device in connection with conveying remote control related command(s) to the home unit. Optionally, the system may be configured wherein the transceiver is configured to communicate with the smart handheld device using a Bluetooth Low Energy (BLE) communications protocol, in connection with the administrative link, to remotely control one or more A/V remotely controllable devices. Alternatively, the system may be configured wherein the processor is configured to determine whether an RC command is received with data received over the administration link and to convert the RCD command to an associated select IR pulse sequence. Optionally, the system may be configured wherein the LED array is arranged such that the IR signals 36 propagate in multiple directions and at multiple angles from the LED array, the IR signals contacting other structures within the entertainment environment and be redirected or reflected in other directions such that the IR signals bounce off multiple structures in the entertainment environment before reaching the RC device, wherein redirection/reflection of the IR signals increases a likelihood that one or more of the IR signals 36 is received by each of the RC device.

### BRIEF DESCRIPTION OF THE DRAWINGS

FIG. 1 illustrates a block diagram of a system formed in accordance with embodiments herein.

FIG. 2 illustrates a block diagram of the IR transmitter subsystem provided within the mobile unit in accordance with an embodiment.

FIG. 3 illustrates multiple alternative or complentary configurations in which the LED array may be arranged in accordance with alternative embodiments.

FIG. 4 illustrates an alternative configuration for the IR transmitter subsystem.

FIG. 5 illustrates an alternative configuration for the IR transmitter subsystem.

FIG. 6A illustrates a top plan view of the IR transmitter subsystem.

FIG. 6B illustrates a side perspective view of the IR transmitter sub-system of FIG. 6A.

FIG. 7 illustrates a schematic representation of the system for Android™ smart handheld devices.

FIG. 8 illustrates a representation of the system where a GATT protocol may be used instead of the SSP protocol in connection with the bidirectional administration link.

FIG. 9 illustrates a schematic representation of an embodiment showing simultaneous connections with multiple SD.

FIG. 10 illustrates a flowchart of a process for managing audio/video streaming communications exchange and priority for multiple SD in accordance with an embodiment.

FIG. 11 illustrates an example of a bidirectional administration communications protocol utilized with the administration link in accordance with an embodiment.

FIG. 12 illustrates a format that may be utilized in connection with individual user configurations associated with an individual HU.

FIG. 13A illustrates a block diagram of a distributed networking environment implemented in accordance with an embodiment.

FIG. 13B illustrates a method for the network of FIG. 13A to manage user configurations for smart handheld devices that communicate through home units to corresponding entertainment environments.

FIG. 14 illustrates a block diagram of a process for managing transfer of communications between multiple SDs and a common home unit.

FIG. 15 illustrates a process implemented in accordance with an embodiment to learn unknown new IR sequences in connection with select commands.

FIG. 16 illustrates a method for collecting viewer behavior information, developing viewer profiles and providing recommendations based on the viewer profile.

### DETAILED DESCRIPTION OF THE PREFERRED EMBODIMENTS

### System Overview

Detailed descriptions of embodiments are provided herein. It is to be understood, however, that the inventions described herein may be embodied in various forms. Therefore, specific details disclosed herein are not to be interpreted as limiting, but rather as representative.

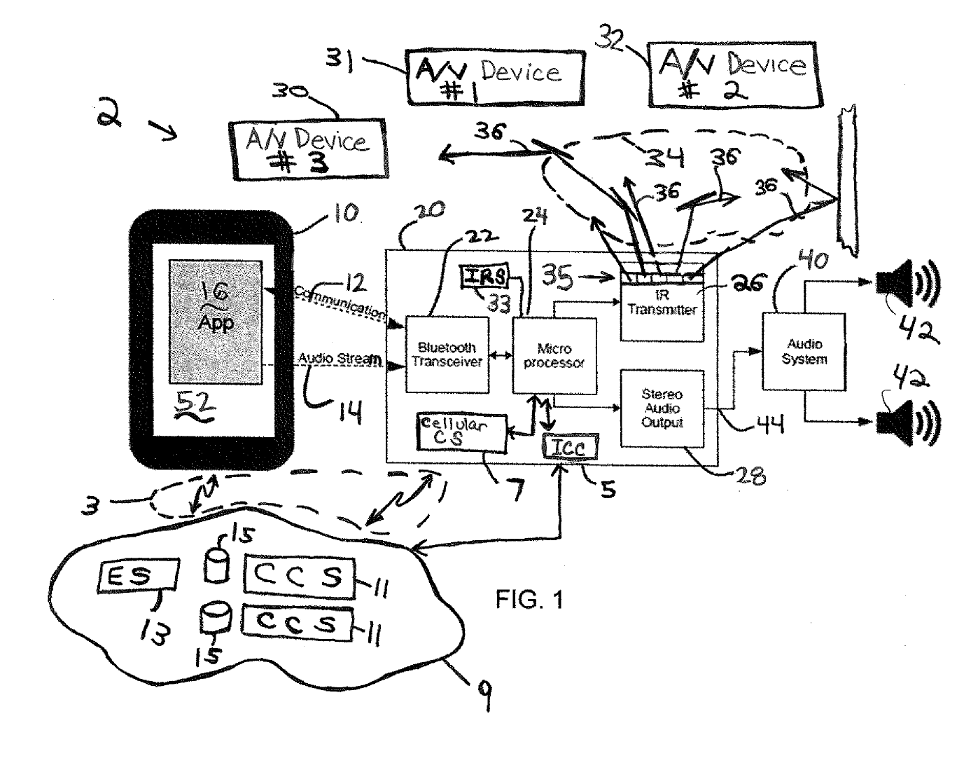

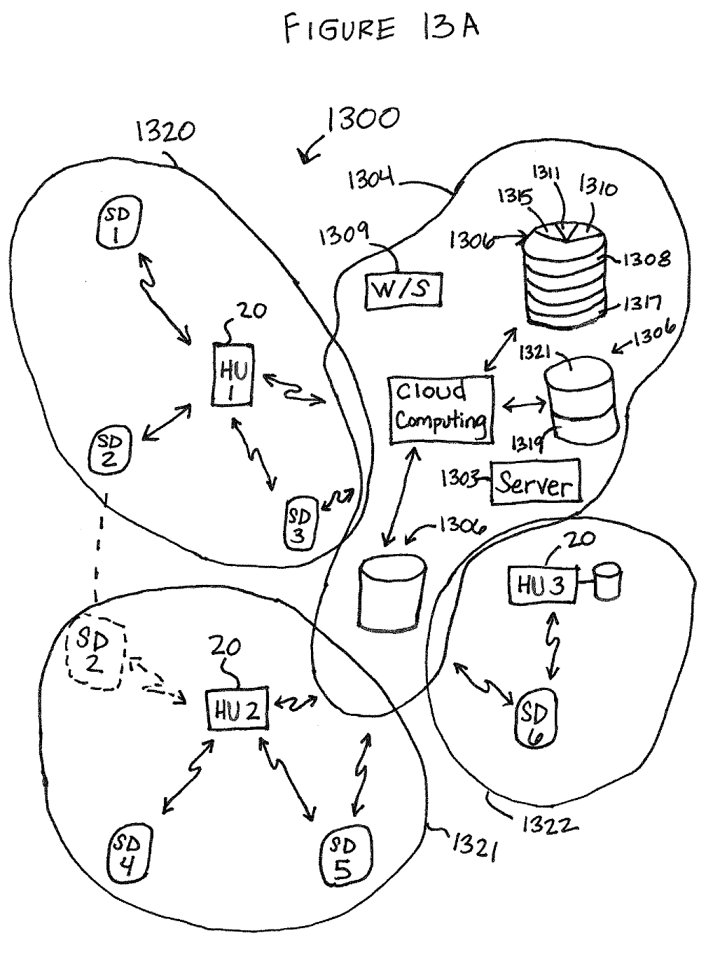

FIG. 1 illustrates a block diagram of a system 2 formed in accordance with an embodiment. The system 2 includes one or more smart handheld devices (also referred to as SDs or mobile devices (MDs)). The SD 10 communicates with one or more home units (HU) 20, which in turn communicate with one or more audio and/or video remotely controllable devices (RCDs) 30-32. The SD 10 includes a user interface 52 having inputs and a display. The user interface 52 is configured to permit the user to enter commands to, among other things, remotely control the RCDs 30-32. The SD 10 and/or HU 20 may be configured to communicate, through a cellular network 3 over the Internet 9 with cloud computing services (CCS) 11 and/or dedicated enterprise server(s) (ES) 13. Data storage 15 is provided over the Internet 9 for storage and access by the CCS 11 and/or ES 13. The CCS 11 and ES 13 perform various functions, analysis, management and the like as explained in connection with various embodiments herein (such as in connection with FIGS. 12-16). The SD 10 may access, download information from and upload information to the CCS 11, ES 13 and data storage 15 through a cellular network connection, a wifi network connection or otherwise. Similarly, the HU 20 may access, download information from and upload information to the CCS 11, ES 13 and data storage 15 through a cellular network connection, a wifi network connection or otherwise. For example, the HU 20 may be configured to include a cellular chip set (e.g., cellular chip set 7) and assigned a cellular phone number in order to afforded a cellular network connection with a subscription cellular network (e.g., ATT, Sprint, Verizon), similar to the cellular chip sets offered in iPAD devices, iTouch devices, and the like. Optionally or in addition, the HU 20 may include Internet connectivity components (ICC) 5, such as a chip set configured to operate as a gateway, router, a network access point and the like.

The SD 10 uploads a streaming and entertainment environment control (SEEC) application 16, such as from an Apple or Google service. The SEEC APP 16 enables the SD 10 to communicate with the home unit 20 over at least two communications links 12 and 14 that exhibit different basic characteristics. For example, one communications link 12, may be referred to as an administration link, and is configured to support unidirectional or bidirectional communication of non-streaming data content, while utilizing limited power, and affording quick or short connect and disconnect sequences to be followed in accordance with establishing a data connection session over one or more data channels. One example of a protocol that affords bi-directional, low power, quick connect/disconnect characteristics is the Bluetooth low-energy protocol.

The other communications link 14, may be referred to as a streaming link 14, and is configured to support at least unidirectional data streaming, with a level of power demand that may be higher than the level of power demand utilized by the administration link 12. The streaming link 14 may also exhibit a more involved connection sequence followed to establish a data connection session over one or more data channels, as compared to the connection sequence followed the administration link 12. The streaming link 14 also exhibits robust data transfer to allow reliable data streaming over mid-range distances. One example of a protocol that supports data streaming with the select network characteristics is the classic Bluetooth protocol.

The communications links 12 and 14 are utilized in connection with different types of data transmission between the SD 10 and HU 20. For example, the SD 10 establishes a temporary low energy BLE administration link 12 with the HU 20 in connection with conveying the remote control related command(s) to the HU 20. The SD 10 establishes a classic Bluetooth streaming link 14 in connection with streaming audio and/or video content from the SD 10 to the HU 20.

The HU 20 includes at least one transceiver 22 that supports one or both of the administration and streaming links 12 and 14. For example, a Bluetooth transceiver 22 may be used to establish a BLE administration link 12 in connection with remote control related operations. For example, the Bluetooth transceiver 22 receives data packets over the link 12, and extracts data from the data packets. The Bluetooth transceiver 22 then passes the data to the microprocessor 24. The microprocessor 24 “unpacks” the data and determines whether the data includes remote control (RC) commands intended for the NV RCDs 30-32. When the data includes RC commands intended for the NV RCDs 30-32, the microprocessor converts the RC commands to a corresponding IR code designating a select IR pulse sequence.

The HU 20 includes, within an IR transmitter subsystem 26, an optical IR transmitter 35, such as single LED or an LED array. The optical IR transmitter 35 comprises LEDs arranged in at least one row and/or at least one column and is discussed in more detail below in connection with FIGS. 2, 3, 4, 5 and 6. The IR code is conveyed from the microprocessor 24 to the IR transmitter subsystem 26. The IR transmitter subsystem 26 drives the optical IR transmitter 35 to cause the LEDs to generate IR signals including the corresponding IR pulse sequence. The optical IR transmitter 35 transmits a corresponding number of IR signals 36 as an IR cluster 34 having the common/same select IR pulse sequence. The IR signals 36 propagate in multiple directions and at multiple angles from the optical IR transmitter 35. The IR signals 36 may propagate in a direct line of sight to an IR receiver at one or more of the AV RCDs 30-32. Optionally, one or more of the IR signals 36 may contact other structures within the entertainment environment and be redirected or reflected in other directions such that the IR signals 36 bounce off multiple structures in the entertainment environment before reaching an RCD 30-32. The redirection/reflection of the IR signals 36 increases the likelihood that one or more of the IR signals 36 is received by each of the AV RCDs 30-32.

The HU 20 also includes a stereo audio and/or video (NV) output 28 coupled to an audio and/or video system 40 over in AV line 44. The audio/video system 40 is coupled to one or more speakers 42 and/or a television or other display.

The SD 10 conveys streaming audio and/or video content over the classic Bluetooth streaming link 14 to the Bluetooth transceiver 22. The Bluetooth transceiver 22 receives the streaming audio/video data and passes the NV data to the microprocessor 24. The microprocessor 24 then unpacks and routes the audio/video data to the NV output 28 that then passes the audio/video data to the system 40 for presentation to the user.

When the SEEC APP is loaded by the SD 10, the SEEC APP 52 enables the SD 10 to communicate the RC commands to the processor that directs the optical IR transmitter to transmit the IR pulse sequences to RC devices based on the RC commands. The SEEC APP 52 maintains, on the SD 10, a customized user configuration associated with the corresponding entertainment environment. The user configuration is set up by a user through the SEEC APP based on individual user preferences. The user configuration comprises a set of input indicia associated with a select RC device, at least a portion of the input indicia indicative of commands for the select RC device, RC commands associated with the input indicia wherein the RC commands identify IR pulse sequences to be transmitted from the optical IR transmitter to the RC device to instruct the RC device to perform one or more associated actions; and a user-designated presentation of the input indicia on the user interface of the SD.

The HU 20 also includes an IR sensor 33 that is configured to sense IR signals. The SEEC APP 52 is configured to learn RC commands for a select RC device, when in a learn mode, by sensing, at the IR sensor, a new IR pulse sequence that is generated by a handheld remote control that is associated with the select RC device; receiving an input indicating a new RC command; and storing the new IR pulse sequence with the new RC command.

FIG. 2 illustrates a block diagram of the IR transmitter subsystem 26 provided within the mobile unit 20 in accordance with an embodiment. The IR transmitter subsystem 26 includes one or more IR drivers 122 that are coupled, over line 130, to an optical IR transmitter 35. The IR driver 122 is controlled by the microprocessor 24 (FIG. 1). The LEDs 124 align with one or more corresponding filter elements 126 and one or more lens components 128. As one example, a separate filter element 126 and a lens component 128 may be provided in connection with each LED 124. Alternatively, clusters or groups of LEDs 124 may be aligned with a common filter 126 and/or lens component 128. The LEDs 124 and filter elements 126 are chosen to provide IR signals at one or more select wavelengths. In at least one embodiment, the LEDs 124 and filter elements 126 are divided into at least two groups, such that one group of LEDs 124 and filter elements 126 produce infrared signals at a first distinct wavelength (e.g. 830 um) and a second group of LEDs 124 and filter elements 126 produce infrared signals at a different second distinct wavelength (e.g., 940 um). Optionally, the LEDs 124 and filter elements 126 may be chosen such that more than two wavelengths of infrared signals may be produced. Alternatively, the entire LEDs 124 may produce only a single wavelength of IR signals. The wavelengths of the IR signals produced are chosen based on the types of audio/video RCDs 30-32 with which the home unit 20 is intended for use. For example, audio/video RCD 30 may be from one manufacturer and respond only to IR signals having a wavelength of 940 um. Audio/video RCD 31 may be from a different manufacturer respond only to IR signals having a wavelength of 830 μm.

A separate lens component 128 may be aligned with each filter element 126. Optionally, multiple filter elements and LEDs 124 may be aligned with a single lens component 128. Optionally, multiple lens components 128 may be aligned with a single filter element 126 and/or LEDs 124.

The lens components 128 are positioned and configured to direct the infrared signals outward from the IR transmitter subsystem 26 at select propagation envelopes where each propagation envelope is directed at a select angle and has a select beamwidth. The propagation envelope, associated with an individual LED 124, has a central longitudinal axis of focus that extends at a select angle from a corresponding lens component 128 (when present). The axis of focus is determined and controlled by the type, shape, position and orientation of the lens. When no lens components are used, the axis of focus extends from the corresponding filter element 126 and/or LED 124.

The propagation envelope, associated with an individual LED 124, has a beamwidth that is defined by outer beam limits. The beam limits extend at a flared angle (or are maintained parallel to one another) as is determined and controlled by the type, shape, position and orientation of the lens. When no lens components are used, the beam limits flare (or extend parallel) at an angle determined by the type, shape, position and orientation of the filter 126 and LED 124.

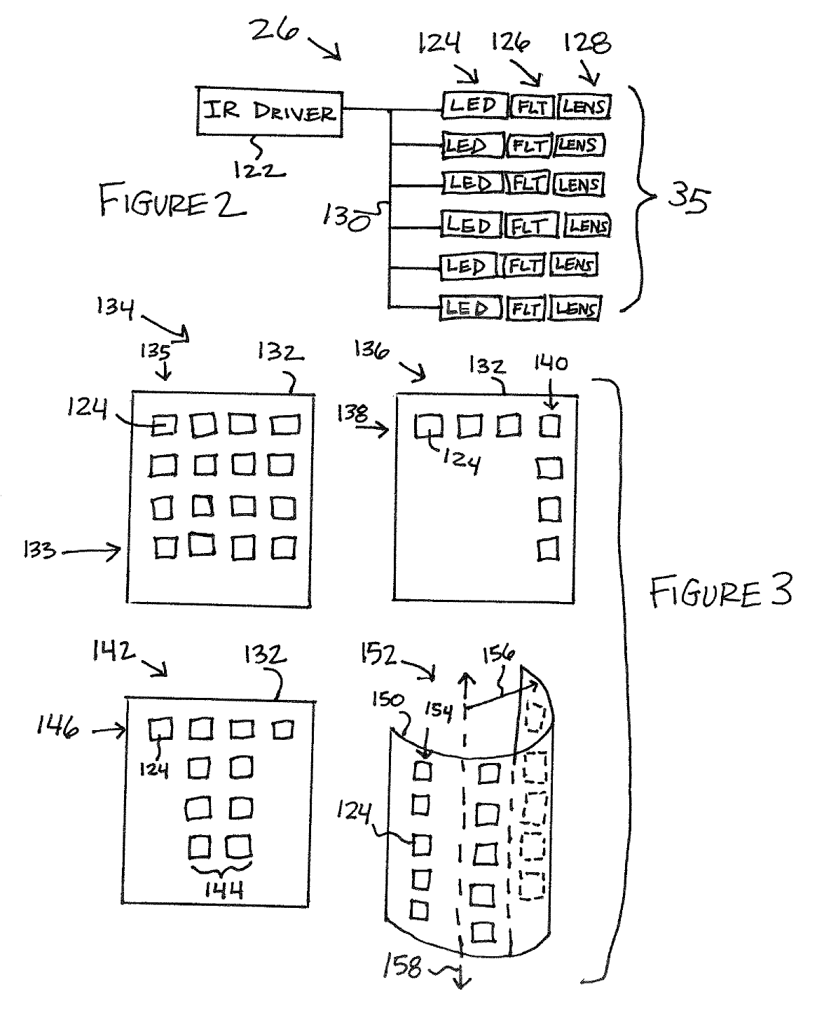

FIG. 3 illustrates multiple alternative or complementary configurations in which the LED array 124 may be arranged in accordance with alternative embodiments. A square array 134 is illustrated in which a substrate panel 132 is provided with a square arrangement of LEDs 124 mounted on the panel 132. The LEDs 124 are arranged in rows 133 and columns 135.

In an alternative exemplary configuration, a curved or L-shaped array 136 is illustrated. The panel 132 has at least a first set of LEDs 124 mounted on the panel 132 and arranged in a horizontal leg 138. The panel 132 also holds at least a second set of LEDs 124 arranged in a vertical leg 140. Optionally, more than one column or row of LEDs 124 may be utilized to form the horizontal leg 138 and/or the vertical leg 140. The horizontal and vertical directions represent general orientations of reference relative to a manner in which the HU 20 is positioned when placed in the entertainment environment. For example, the HU 20 may include a base on which the HU is configured to sit/rest, such as when placed on a shelf, end table, floor, wall mount, RCD, and the like.

In an alternative or additional configuration, a T-shaped array 142 may be used in place of or in addition to the L-shaped array 136 and/or square array 134. The T-shaped array 142 includes LEDs 124 arranged in a first set aligned to form an arm 146 and in a second set aligned to form a base 144. Optionally, more than one row of LEDs 124 may be used to form the arm 146. Optionally, only one column (or more than two columns) of LEDs 124 may be used to form the base 144.

In an alternative or additional configuration, a tubular array 152 may be provided to be used alone or in combination with other array configurations. The tubular array 152 comprises a curved panel 150 with LEDs 124 provided there on. The curved panel 150 is shaped with a select radius 156 extending outward from a longitudinal axis 158. The LEDs 124 are arranged in columns 154 about (and face outward from) the exterior surface of the curve panel 150. In the example of FIG. 3, the panel 150 is curved in approximately a half semi-circular shape such that opposed columns 154 of LEDs 124 face in substantially opposite directions at approximately 180° apart from one another. Alternative and additional configurations LEDs 124 may be provided and oriented to face in alternative and additional directions.

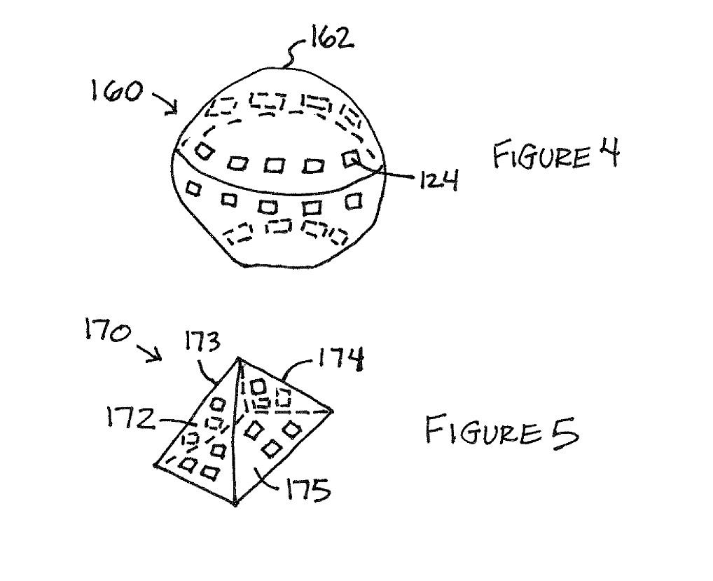

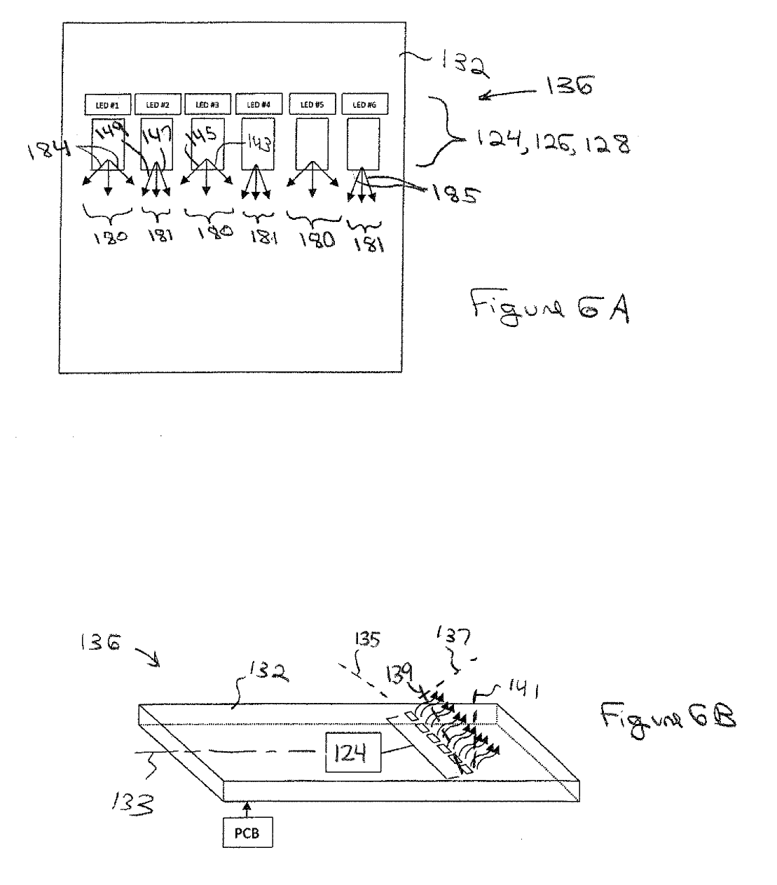

FIG. 4 illustrates an alternative configuration for the IR transmitter subsystem 160. The IR transmitter subsystem 160 is provided upon a three dimensional (3D) spherically shaped panel 162 having LEDs 124 distributed about the spherical panel 162. The LEDs 124 are positioned to face outward in multiple directions from the panel 162. A portion of the LEDs 124 are shown in dashed lines to indicate LEDs 124 that are facing in an opposite direction (away from the drawing sheet) from the LEDs shown in solid line.

FIG. 5 illustrates an alternative configuration for the IR transmitter subsystem 170. The IR transmitter subsystem 170 is provided with a collection of panels 172-175 arranged to form a 3D pyramid shape with a rectangular base. The LEDs 124 provided on panels 173 and 174 are shown in dashed lines. The LEDs 124 provided on the panels 172 and 175 are shown in solid lines.

Optionally, additional and alternative two-dimensional and three-dimensional shapes may be utilized for the IR transmitter subsystem, as well as additional and alternative arrangements for the LED arrangements. Optionally, different surfaces of the IR transmitter subsystem 160 may include different combinations and different arrangements of LEDs. Optionally, a single LED may be used to transmit all IR signals. As one example, a single LED may be used in connection with multiple filters and lens that filters the signals emitted by the LED into different select wavelengths. For example, a single LED may emit a signal having multiple wavelength components. A first filter may pass only a first select wavelength/wavelength range, while a second filter may pass only a second select wavelength/wavelength range, while a third first filter may pass only a third select wavelength/wavelength range. The single LED may be joined to multiple lenses that are configured to have different select directionality. For example, a first lens may be configured to emit a narrow beamwidth, highly directional signal, while a second lens is configured to emit a wider beamwidth, low directionality signal.

FIG. 6A illustrates a top plan view of the IR transmitter subsystem 136. As shown in FIG. 6, the IR panel 132 has a plurality of LEDs, filters and lenses 124, 126 and 128 provided there on. The lenses 128 are configured to provide different propagation envelopes 180-181. For example, a first subset of LEDs 124 (e.g. outer and central) may be coupled to lenses 128 that provide a first propagation envelope 180 having low directionality and a wide beamwidth as denoted by arrows 184. As another example, a second subset of LEDs 124 (alternating between the elements of the first subset) may be coupled to lenses 128 that provide a second propagation envelope 181 having high directionality and a narrow beamwidth (relative to the beamwidth of the first propagation envelope 180). The second propagation envelope 181 is denoted by beam limits 185.

The beam limits 184,185 may be varied for select LEDs, and may vary laterally as well as vertically. For example, the lateral (e.g. horizontal) beam limits 184, 185 may be relatively wide and equally dispensed about a central axis perpendicular to the face of the panel. Optionally, vertical beamwidth limits 184, 185 may differ from one another such that the IR signals propagate outward and upward, and do not necessarily propagate downward in an equal amount, (e.g., uneven vertical directionality).

FIG. 6B illustrates a side perspective view of the IR transmitter sub-system of FIG. 6A. As shown in FIG. 6B, the LEDs 124 may be located at an intermediate point on the IR panel 132 and arranged in a single row or column. The LEDs 124 may be oriented to transmit outward from a surface plane of the IR panel 132 at a select angle. For example, when the IR panel 132 is oriented to extend along a longitudinal axis 133, the LEDs 124 may be arranged in a row to traverse the axis 133 laterally. The LEDs 124 with low directionality may be configured to exhibit a beamwidth with longitudinal limits 135, 137, while the LEDs 124 with high directionality may be configured to exhibit a beamwidth with longitudinal limits 139, 141. The longitudinal limits 133-141 are measured at an angle relative to the surface plane of the IR panel 132 along the longitudinal axis.

The LEDs 124 with low directionality may be configured to exhibit a beamwidth with lateral limits 143, 145 (FIG. 6A), while the LEDs 124 with high directionality may be configured to exhibit a beamwidth with lateral limits 147, 149. The longitudinal limits 143-149 are measured at an angle relative to the surface plane of the IR panel 132 and at a perpendicular (transverse) relative to the longitudinal axis.

The LEDs 124 may be configured to transmit across all or any portion of a predetermined IR wavelength range (e.g., 700 um to 1 mm).

The processor 24 controls the blinking pattern of the IR LEDs in the first and second subsets in a common manner. Thus, the first and second subsets of LEDs transmit a common IR pulse sequence (IR code) associated with a common RC command. In this manner, a common IR code is transmitted in different directions and from IR sources having different amounts of directionality, and different beamwidths. The variations between beamwidth and directionality create an inter leaved or mesh pattern of IR signals that cross, reflect and re-cross an entertainment environment.

Optionally, the first and second subsets of LEDs 124 may be duplicated, but at different IR wavelengths. For example, RCDs 30 may be responsive to IR signals at a first wavelength (e.g., 830 μm) while other RCDs 31 are responsive to IR signals at a second wavelength (e.g., 940 μm). The LED array 136 may include first and second subsets of LEDs 124 that operate at 830 μm, and the LED array may further comprise third and fourth subsets of LEDs that operate at 940 μm. The third and fourth subsets of LEDs would have similar directionality, angular directions, and beamwidth as the first and second subsets of LEDs.

Optionally, more subsets may be defined with separate directions, directionality, beamwidths, wavelengths and the like. Hence, more than two subsets of LEDs may be provided for each wavelength.

An easy-to-use graphic interface on the smart handheld device 10 provides the configurations and choices concerning the operation of the system. A software application, referred to as an “SEEC APP,” 16 is designed to run on smart handheld devices. The SEEC APP 16 provides easy, user-friendly graphic interface screens for users to indicate their control choices, to view status and to give and receive feedback from the wireless audio receiver. There may be two or more modes of interface with the wireless audio receiver. One mode represents a unidirectional or bidirectional administration link 12 with the wireless receiver and the other mode represents an audio and/or video streaming link 14, over which NV signals may be sent to the audio and/or video RCDs 30-32 and/or audio/video system 40.

Variations in the SEEC APP are available to conform the SEEC APP to the requirements of the different smart handheld device 10 platforms. Using the stored SEEC APP 16, the smart handheld device 10 sends wireless signals to the processor 24. The processor 24 coordinates the signals coming from smart handheld device 10 in order to provide the control functions desired, and to provide overall coordination for the system. The processor 24 then sends the appropriate instructions to controlled RCD 30-32 and/or audio/video system 40 based on the received commands from the smart handheld device 10.

The smart handheld device 10 may utilize various communications protocols to provide the links 12 and 14, where such protocols afford certain functionality and performance levels. In accordance with embodiments herein, the Bluetooth Low Energy (BLE) communications protocol is utilized by the smart devices 10, in connection with the communications link 12, to remotely control one or more NV RCDs 30-32 and for audio and/or video streaming to the audio/video system 40.

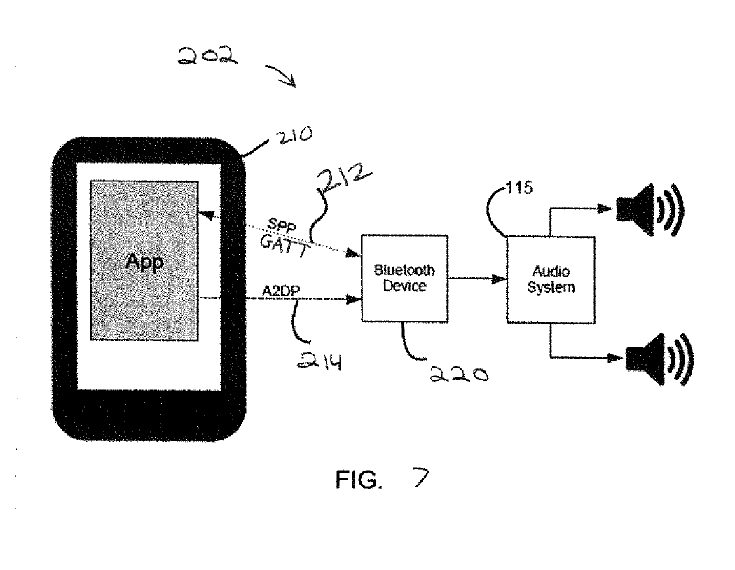

FIG. 7 shows a schematic representation of the system for Android™ smart handheld devices 210. The system uses the Bluetooth SPP profile and A2DP profile. The SPP profile is used for a bidirectional administration link 212 between the home unit 220 and the smart handheld device 210. The administration link 212 conveys SPP or GATT messages include firmware updates, IR codes, and access requests. The SPP profile permits the home unit 220 to be connected to multiple smart handheld devices 210 simultaneously. Optionally, the devices 210 may use the GATT profile for the administration link.

The streaming link 214 utilizes the A2DP profile to stream audio and the video distribution profile (VDP) to stream video from the smart handheld device 210. The A2DP and VDP profiles represent unidirectional profiles and allow only one smart handheld device 210 to be connected to the home unit 220 at one time. When the system 202 seeks to offer the streaming A/V functionality from more than one SD 210 with a single HU 220, the system 202 uses the A2DP and/or VDP profiles and the communications link 212 to negotiate a transition from one SD 210 to a new SD 210 for streaming A/V over the streaming link 214.

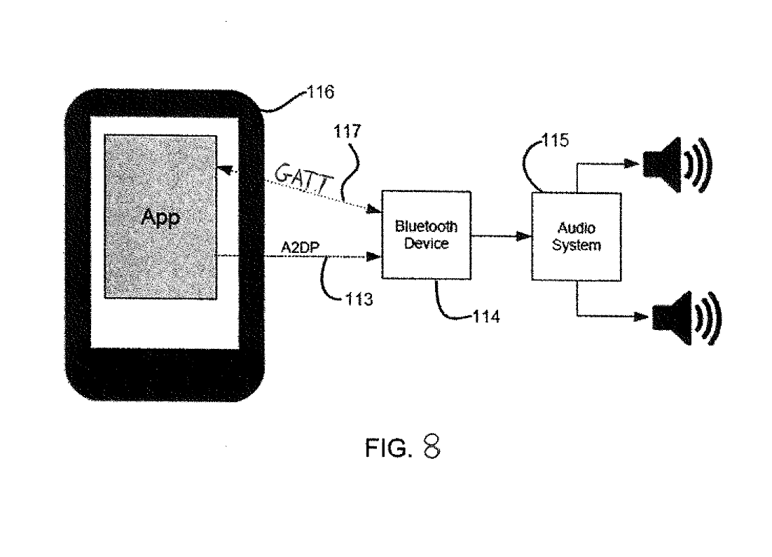

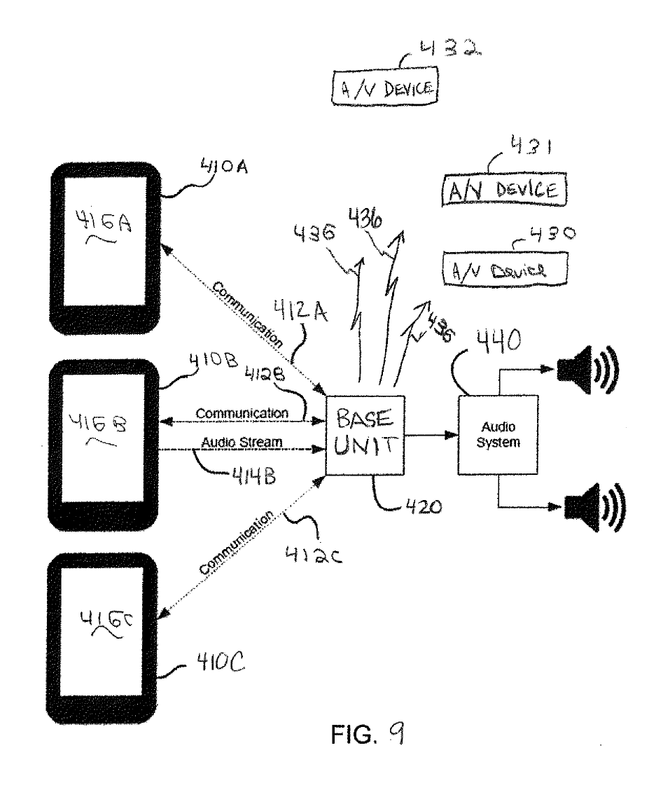

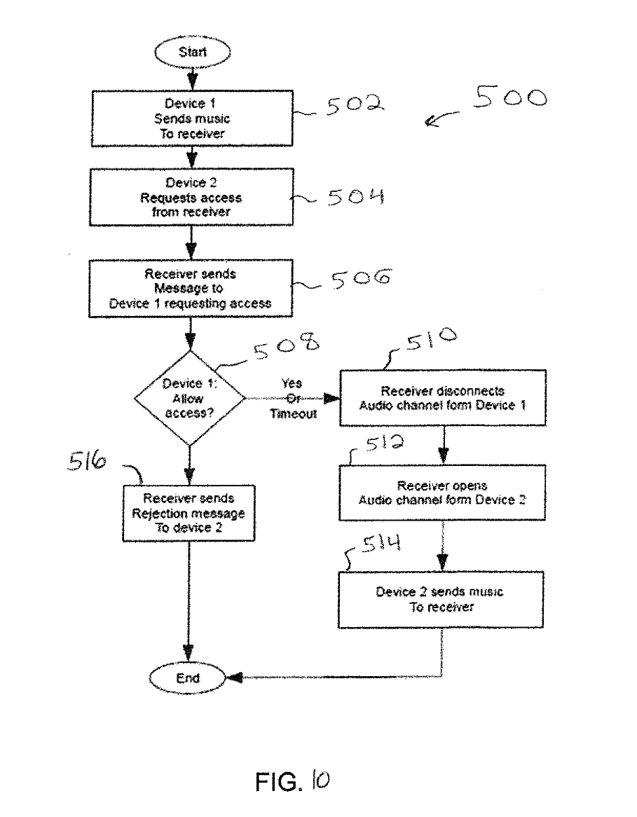

FIG. 8 illustrates a representation of the system where a GATT protocol may be used instead of the SSP protocol in connection with the bidirectional administration link 117 between the SDs 116 and BUs 114. The GATT protocol may be used with SDs 116 that utilize the iOS and Android operating system. GATT is one of the core protocols of Bluetooth 4.0 Low Energy specification. The HU 114 is connected to an audio system 115.

FIG. 11 illustrates an example of a message sequence chart to establish a bidirectional administration link. By way of example, there are 4 basic modes a BLE enabled smart device can operate—master device mode, slave device mode, advertising mode, and scanning mode. An advertising mode is used by the HU 20 to periodically advertise information that can be used to establish a link. For example, the HU 20 periodically transmits advertisement packets 1102 over the advertising channel(s). When the SEEC APP 16 on the smart devices 10 is opened or when a user enters a remote control command 1104, the SD 10 initiates an advertisement search sequence 1106. In the AD search sequence 1106, the SD 10 begins monitoring the advertisement channels for advertisement packets from a HU 20. When the SD 10 sees/detects an advertisement packet 1102 from a HU 20 associated with the SD 10, the SD 10 responds by transmitting an advertisement acknowledgement 1108 over the advertising channels. The HU 20 detects the advertisement acknowledgement.

During advertising, the HU 20 transmits advertising packets over of the available designated, advertising channels in a predetermined channel hopping manner and at a predetermined rate, such as at a rate from 20 ms to every 10 seconds depending on the configuration. When an advertisement search sequence is initiated, the scanner SD 10 is configured to search for advertising packets in scan windows 1110 (e.g., the amount of time that the HU 20 or SD 10 looks for advertisement packets) and a scan interval (how often in between scans). Once the HU 20 detects an advertisement acknowledgement 1108, the scanner HU 20 supplies the advertiser SD 10 with connection related information 1112, namely the connection interval and slave latency. The connection interval is used to determine the start time of connection events 1114. A connection event 1114 is the exchange sequence of data packets. The other parameter, the slave latency is the amount of connection interval a slave device can ignore without losing the connection. This is done to improve power consumption.

The HU 20 also informs the SD 10 of which data channel(s) to begin data packet exchange over to establish a communications connection link. After the link is established, communication is carried out over the 37 data channels. Each data packet represents a packet data unit that comprises up to 37 bytes of payload, along with a packet header, and a Message Integrity Check. A communications event is initiated by a master device (SD or BU) with communications alternating between master/slave until one of them stops transmitting.

In accordance with the BLE protocol, the HU 20 can also use the advertise mode to respond to additional queries from another smart device. Scanning mode is used by the HU 20 to capture advertise packets transmitted from the one or more SDs 10. Slave and Master Modes are used once a link has been established between one SD 10 and a HU 20, and allow the SD 10 and HU 20 to read, write, and query each other. The HU 20 that starts out in Advertise Mode may assume the slave device mode and conversely the SD 10 that is initially in the scanning mode may assume the master device mode.

In accordance with the BLE protocol, there are 2 primary types of packets that may be transmitted between the SD 10 and HU 20, namely data and advertise packets, each with variable lengths. For example, the data packets may comprise an 8 bit preamble, 32 bit access codes that are defined by the RF channel used, a variable PDU ranging from 2-39 bytes and a 24 bit CRC. Hence, a data packet may be as small as 80 bits or as long as 376 bits. As the data packet length changes, the transmission time also changes. For example, a transmission time may range from 80 microseconds to 0.3 milliseconds. Advertise packets on the other hand, have PDU containing a 16 bit header and up to 31 bytes of data.

In accordance with the BLE protocol, the HU 20 and SD 10, or multiple SDs 10 may associate with one another in three different manners, generally referred to as Just Works, Out of Band, and Passkey Entry. An advertising SD transmits packets on the advertise channels with a packet data unit (PDU) containing the device address and up to 31 bytes of additional information. A scanning HU 20 is able to see the address, within the advertisement packet, and depending on the advertiser SD 10, the HU 20 may request additional information that is then sent from the MD 20. Accordingly, in optional embodiments, the system may exchange large amount of information from the SDs 10 to the HU 20 through the advertisement channel without establishing a communications connection session over the data channels.

The BLE protocol stack is partitioned into a controller and a host. The controller handles the lower layers of the stack responsible for capturing physical packets and the RF used by the radio. The host handles the upper layers of the stack; they include the application, attribute protocol, and L2CAP. The host and controller can be either collocated or the host can run in the application processor with the application. In the second option, a hardware controller Interface (HCl) is used by the controller and host to communicate. The controller communicates with the Logical Link Control and Adaptation Layer (L2CAP) protocol via the HCl or directly if collocated. The main function of the HCl is to provide data services to the upper level layers and for multiplexing and segmenting packets into fragments for the controller. The HCl also reassembles packets from the controller before they are routed to the upper level layers.

The Generic Access Profile (GAP) is responsible for defining generic procedures that are used in the pairing and linking of the HU and MD. The GAP is the interface for the application layer to implement the different Bluetooth modes (Advertising, Scanning, etc.). The Security Manager (SM) is used for authentication and encryption and uses AES-128 bit encryption engine to do so and is also responsible for pairing and key distribution. This component is used by the Master device to ease the computing demands of security on the Slave device. The Attribute protocol is a communication method designed to optimize transmission of small packets. ATT are pairs of attributes and values that can be used to read, write, or discover by other devices.

Another component is the Generic Attribute Profile (GATT) it is responsible for describing the different service frameworks and is an extension to ATT that is specific to Bluetooth LE4.0. It interfaces with the application layer through the application profiles. Each application profile defines data formatting and how it should be interpreted by the application. Profiles improve on power efficiency by reducing the amount of data being exchanged.

The BLE or similar protocol, utilized to communicate between the SDs 10 and HU 20 achieves increased power efficiency. First, a lower duty cycle is used, such that the SDs 10 go to sleep for longer periods of time and wake up less frequently to send or receive packets as compared to classic Bluetooth and other protocols. Second, using the GATT profiles allows the SDs 10 to send smaller data packets (expose state) (relative to classic Bluetooth) in short bursts to save on power. Data transmission sessions can be triggered by a local event, such as an input by the user of the SD 10, and is available for an SD user to access at any time. The administration link utilizes communications sessions having a data transfer defined length. The length of each communications session is dependent and defined by an amount of active data transfer. The SDs 10 do not maintain communications sessions or links with the HU 20 or other SDs 10 whenever the SD 10 is not actively performing exchange of data. When the SD 10 ceases to transmit or receive data packets for a predetermined period of time (e.g., 5 sec., 20 sec., 30 sec.), the SD 10 goes to sleep and ends the communications session or link. A link is rapidly re-established upon the next communication exchange (e.g., when the user opens the SEEC APP or selects an RC command.

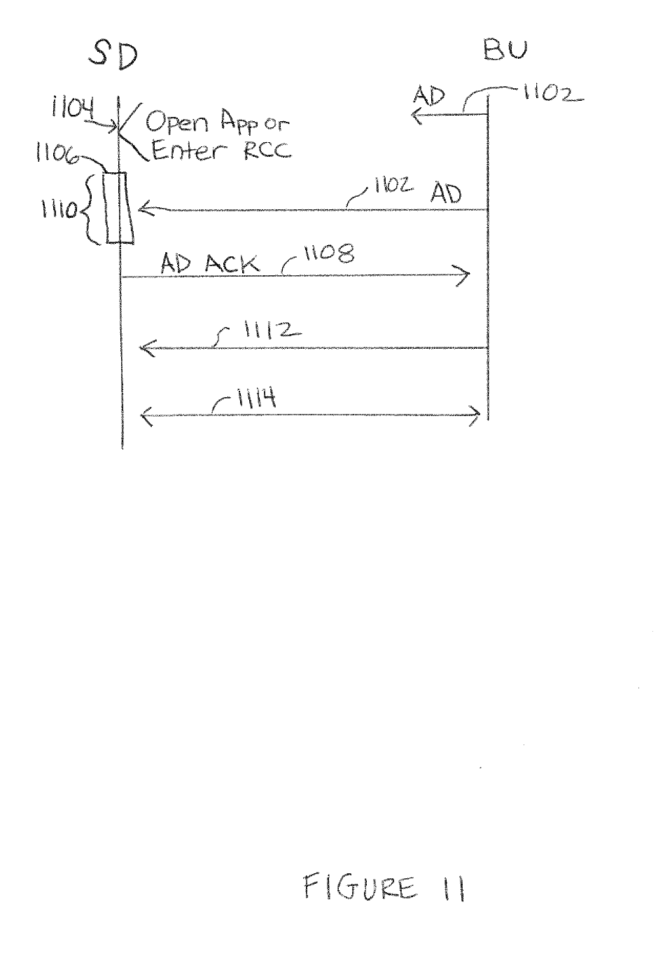

FIG. 9 is a schematic representation of an embodiment showing simultaneous connections with multiple SD 410A-410C. The SD 410A-410C may utilize the same or different operating systems. For example, a subset of the SD 410A-410C may utilize the iOS operating system, and another subset of the SD 410A-410C may utilize the Android™ operating system. The SD 410A-410C that utilize the iOS use a GATT protocol for the bidirectional link 412, while the SD 410A-410C that utilize the Android™ OS use the SSP protocol for the bidirectional link 412. The GATT (iOS) and SPP (Android™) wireless communication technologies used in the embodiment are representative of types of communication that may be applied. A wide variety of other wireless communication technologies may be applied in alternative embodiments.

The system 402 is configured to permit easily switching the remote control and audio streaming operation from one SD 410A-410C to another by utilizing a setting feature in the SEEC APP 416A-C. The SEEC APP 416A may operate in automatic mode or in a responsible. When the setting is in the automatic mode, any requesting idle SD 410A-410C is automatically accepted and connected to the home unit 420. In order to stream audio through another “idle” smart handheld device 410, the idle smart device 420 sends a request to stream audio to the wireless HU 420 which in turn forwards the request to the active smart device. When the active smart device 410 denies the request, the wireless HU 420 sends a denial message to the requesting idle smart device 410 and the active smart device 410 continues to stream music to the wireless HU 420 and finally to the audio system 440.

When the active smart device 410 accepts the request or does not respond to the request in a timely manner, an acceptance is forwarded to the idle smart device 410 through the wireless HU 420. The existing audio streaming connection is terminated and a new audio streaming connection is initiated between the requesting “newly activated” smart handheld device and the wireless audio receiver. The system 402 may also hand off links between SDs 410 A-C in accordance with the method of FIG. 14.

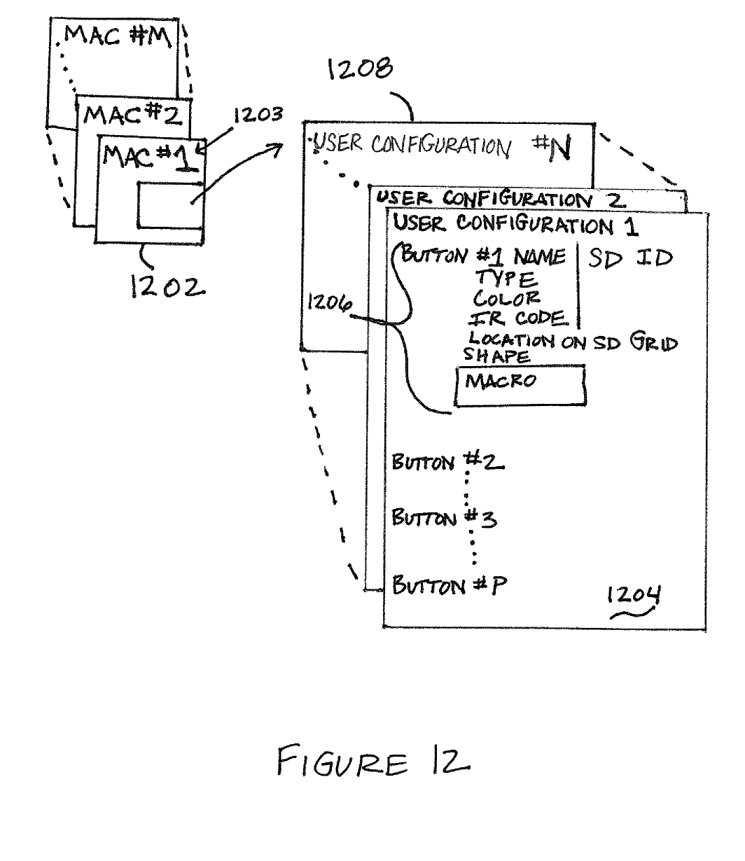

When the setting is in response mode, the control of the home unit 420 operates in accordance with the flow management illustrated in FIG. 10.

FIG. 10 illustrates a flowchart 500 of a process for managing audio/video streaming communications exchange and priority for multiple SD 410A-410C in accordance with an embodiment. In case of multiple smart handheld devices being used as remote control and audio streaming devices for the home unit 410 connected to an audio system 440, beginning at 502, bidirectional communication (e.g. over an administration link 412A-412C) is established between all SD 410A-410C and the home unit 420. In the exemplary embodiment, only one active SD 410A-410C is permitted to establish an audio streaming link 414B with the HU 420 in order to stream music or other audio/video content to the audio/video system 440. At 502, and SD 410B begin streaming music to the HU 420 over the streaming communications link 412B. At 504, another SD 410A sends a request to the HU 420 (e.g. over the administration link 412A) seeking to establish a streaming A/V communications link 414 with the HU 420.

At 506, the HU 420 sends a streaming transfer permission request (over the administration link 412B) to the active SD 410B to request (from the SD 410B) permission to transfer A/V streaming functionality to the SD 410A.

At 508, the active SD 410B determines whether to grant permission to transfer the streaming functionality from the SD 410B to another SD, such as SD 410A. The determination may be performed automatically or manually. For example, the SD 410B may have a user-entered setting chosen within the SEEC APP 416B such that the SD 410B will automatically grant or deny requests to transfer streaming functionality. The user may change the setting through the SEEC APP 416B. Optionally, the SEEC APP 416B may prompt the user, each time a request is made at 508, with the user deciding whether to grant the transfer.

When transfer is granted, flow moves to 510; otherwise flow moves to 516. At 510, when transfer is granted by the active SD 410B, the HU 420 initiates a streaming transfer routine. In the streaming transfer routine, at 510, the HU 420 and SD 410B disconnect the streaming communications link 414B. At 512, the HU 420 and SD 410A establish a streaming communications link 414A by opening an audio/video streaming channel. At 514, the newly activated SD 410A begins streaming audio and/or video over the link 414A.

Returning to the decision at 508, when the SD 410B determines to deny access by the requesting idle SD 410A, flow moves to 516. At 516, the HU 420 sends a rejection message (over the administration link 412A) to the requesting idle SD 410A and the process ends. The process of FIG. 10 may be repeated each time an SD 410A-C makes a request for access to stream NV content.

FIG. 14 illustrates a message sequence chart for managing transfer of communications between multiple SDs 410B-C and a common home unit 420. In FIG. 14, the vertical lines denote the source/destination (e.g., SD 410B, SD 410C, HU 420) with time progressing from top to bottom in FIG. 14. Breaks are illustrated in each vertical line to denote different communications sessions or alternative methods for managing transfer.

Beginning at communications session 1410, in the upper left portion of FIG. 14, the SD 410B and home unit maintain an administrative link 1412 and streaming link 1414. In one embodiment, when an administrative link 1412 is maintained with one SD, the home unit 420 ceases/terminates advertising operations while the link 1412 is maintained. Hence, while the link 1412 is maintained, other SDs (SD 410C) cannot “find” the home unit as no advertisements are produced over any advertising channel.

During a separate communications session 1420, the SD 410B may be streaming audio/video to the home unit 420 over the streaming link 1414, without maintaining an administration link. Hence, during communications session 1420, the home unit 420 periodically transmits advertisements 1416 over the advertising channels. The SD 410C receives the advertisement 1416 and replies with an advertisement acknowledgment and request 1418 to initiate an administration link with the HU 420. Given that the HU 420 is not currently maintaining an administration link, the HU 420 coordinates with the SD 410C to initiate administration link 1422. In this manner, during session 1420, the HU 420 maintains a streaming link 1414 with SD 410B and an administration link 1422 with SD 410C.

During communications session 1430, the SD 410B and home unit 420 maintain an administration link 1432 and streaming link 1434. As an alternative embodiment, the home unit 420 may be configured to broadcast advertisements 1436, even while maintaining administration and streaming links 1432 and 1434. In this alternative embodiment, the SD 410C is able to find the home unit 420, even while the home unit 420 maintains administration and streaming links 1432 and 1434. Once the SD 410C receives advertisement 1436, the SD 410C returns an advertisement acknowledgment and request 1438 seeking to initiate an administration and/or streaming link.

The HU 420 may handle the acknowledgment and request 1438 in various manners. For example, the home unit 420 may ignore the acknowledgment and request 1438. Alternatively, the home unit 420 may automatically grant the acknowledgment and request 1438 by terminating the administration and streaming links 1432 and 1434 with SD 410B. The dashed line 1433 denotes termination of the links 1432 and 1434 to end session 1430. As a further alternative, the home unit 420 may query the user of SD 410B to determine whether to grant permission to transfer the communication session to SD 410C. When the user of SD 410B grants permission to transfer communication, the session 1430 is terminated by the HU 420 and session 1440 is initiated in which the home unit 420 begins to receive streaming audio/video over link 1444 from the SD 410C. During session 1440, the home unit 420 and SD 410C also pair to initiate administration link 1442.

In accordance with embodiments herein, the administration link protocol utilizes very low power as compared to classic Bluetooth. The power consumption at the SD is dependent on the SD transmit time and number of sessions. As an example, SD's may utilize a transmit time of up to 50 ms, and more preferably approximately 10-25 ms, to establish a communications session, transmit user selected remote control instructions, and after a select period of time disconnect the communications session.

Optionally, the SDs 10 and HU 20 may be configured to encrypt communications there between over the communications link 12 and/or streaming link 14. Various encryption methods may be used. For example, when the BLE or classic Bluetooth protocols are utilized, the encryption methods provided within BLE or classic Bluetooth may be used.

Optionally, encryption may be an upgrade offered through a firmware upgrade after installation of the HU 20. For example, the HU 20 and SEEC APP on one or more SDs 10 may be set up in a home and at a later date, it may become desirable to add encryption. To do so, a firmware upgrade may be pushed to the SD 10 (or sent by email to a user). The SD 10 that in turn ports the upgrade to the HU 20. Alternatively, the SD 10 and/or HU 20 may periodically check for upgrades over an Internet link, or a cellular link with a network server located in the Cloud. An upgrade then may be downloaded.

FIG. 12 illustrates a format that may be utilized in connection with setting and maintaining individual user configurations. When a home unit 20 is initially set up in an entertainment environment, user configurations 1208 are programmed by the user. During set up, the user enters the different types of audio/video equipment within the environment, among other things. In addition, the user has the option to customize the presentation of the input indicia (e.g., slide bars, buttons) displayed on the SD in connection with each audio/video device. For example, for a cable set top box, the user may desire certain input indicia, such as buttons to be displayed on the user interface of the SD in a select presentation, such as in a select combination, arrangement and orientation. The user may desire a different combination of buttons and/or different arrangement or orientation of buttons to be displayed on the user interface of the SD in connection with an audio receiver, as well as a different combination, arrangement or layout of buttons for a television. Further, different users within a single entertainment environment may prefer different combinations, arrangements or layouts of buttons for a common RCD. For example, a left-handed person may desire one configuration of buttons, while a right-handed person desires a different configuration. As a further example, a parent may desire one combination, while children desire a different configuration. Similarly, husbands and wives may desire different configurations of buttons.

During set up, each user is afforded the opportunity to customize the positions of the input indicia, as well as which combinations are displayed in connection with each device to be remotely controlled. In accordance with at least one embodiment, a display of the SD is virtually segmented into a table having rows and columns were each cell within the table of rows and columns defines an associated area on the display of a smart phone. For example, if the display is divided into five virtual columns and eight virtual rows, then 40 potential discrete cells exist on the display at which input or output indicia may be displayed. The input indicia may include virtual or soft buttons and slider bars associated with select commands or macros; icons associated with RCDs, macros or service providers (e.g., iTunes, Netflix, etc.), other functional operations (music library, etc.) and the like. The output indicia may include information regarding RCDs, the HU, the SD and the like. The output indicia may present video or text in windows, graphs, program lists, program related information (e.g., description of program, length, actors, etc.), and the like.

For example, cell number 1 may represent the upper left-hand corner of the display, while cell number 5 represents the upper right-hand corner, cell number 35 represents the lower left-hand corner and cell number 40 represents the lower right-hand corner. The user may select various characteristics in connection with input indicia, such as the name to be displayed for a button, the type of button relative to the device to be remotely controlled, the button color, the shape and the like. In addition, a unique IR code is associated with each input indicia based upon the type and function assigned to the button relative to the device to be remotely controlled.

Optionally, the user may program macros to be implemented in response to selection of a single input indicia. For example, a macro may include a series of instructions to turn on multiple remotely controlled devices in a select order. For example, by pressing a single button, the user may activate a macro that turns on a TV, a Cable set top box and an stereo receiver. The macro may also instruct the receiver to turn its input to the connection coupled to the cable box or TV, and instruct the TV to turn its input to the cable output.

As illustrated in FIG. 12, each home unit 20 is assigned a unique MAC address 1203, and user login (username and password). Each MAC address 1203 and/or username and password is uniquely associated with a record that stores various types of information associated with the corresponding home unit 20. The record may be stored locally on the home unit 20, within one or more SD, on a remote server, or at a storage location within the cloud. Records are stored for every home unit 20 once a user has configured the home unit 20. The records may be stored at a common remote data storage, warehouse, network or within the cloud, and the like. Alternatively or in addition, the records may be stored locally, such as on the home unit 20, locally on another network computer within the home entertainment environment, on the users SD and the like.

When a user activates the application on an SD, the application first pairs with an HU and receives the MAC address of the HU. The SD then determines whether a user configuration is loaded in the SD associated with the MAC address of home unit 20 with which the SD has paired. When the SD does not have the user configuration associated with the home unit 20, with which the SD is paired, the SEEC APP seeks a correct user configuration set-up for the home unit 20 from a management server or other destination (e.g., over the Internet, Cloud, on the home unit 20 or elsewhere). To locate a valid user configuration, the SEEC APP sends a request that includes the MAC address of the home unit 20 to the appropriate destination (server, HU, cloud).

As shown in FIG. 12, a record 1202 is stored in connection with each MAC address. Among other things, the record 1202 includes one or more user configurations 1204. Each user configuration 1204 may include information associated with the user for which the configuration was set up, such as the username, viewer profile, program guides and other demographics. The user configuration 1204 also includes button specific information 1206 in connection with each input indicia programmed by the user for each device to be remotely controlled. In the example of FIG. 12, the buttons for user configuration #1 are only shown for a single device. Multiple sets of button specific information may be stored in the user configuration #1 depending upon the number of devices that the user has configured the smart phone to control.

In connection with one device, the user configuration includes button specific information 1206, such as the button name, button type, color, IR code to be transmitted when the button is selected, button shape and location on the smart phone virtual grid. The button specific information 1206 may also include one or more macros to be implemented when the button is activated. By way of example, the location information may indicate the row and column of the cell or cells in which the input indicia is to be displayed. The same types of information, as illustrated for button number #1 may also be recorded for any desired number of additional input indicia #P.

Optionally, the program guide and other entertainment environment specific information may be stored in the user configuration, or elsewhere.

As explained above, a separate user configuration may be set up for different members of the household, such as one configuration for the wife, one configuration for the husband, one configuration for various kids. Also, a separate configuration may be set up for left-handed people, as well as for right-handed people. Inappropriate configuration is loaded when the corresponding smart phone is paired with the home unit 20. When multiple user configurations are recorded in connection with a single home unit, each user configuration may be associated with a particular smart phone, a particular user ID and the like.

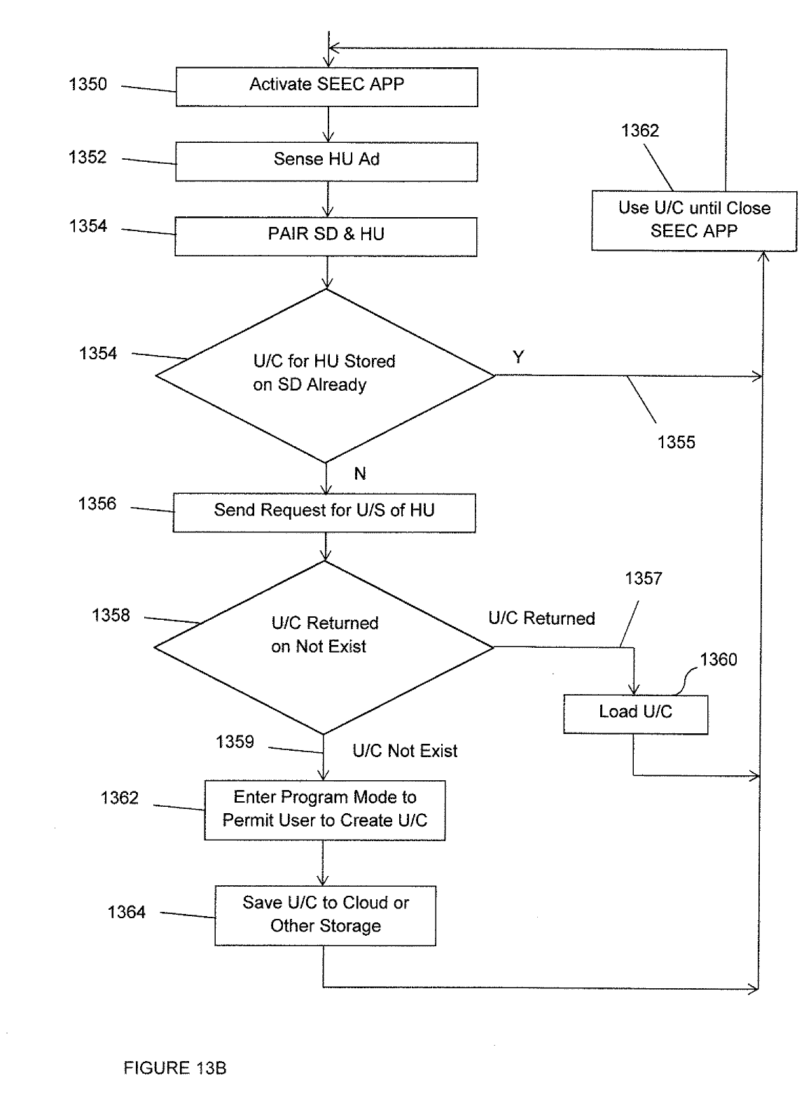

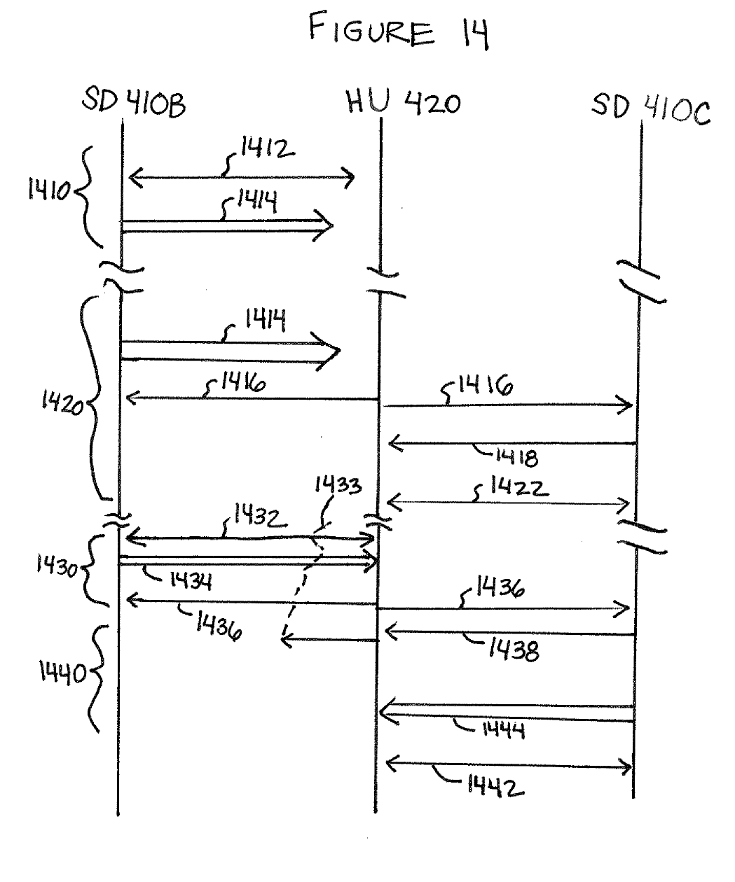

FIG. 13A illustrates a block diagram of a network 1300 for a distributed networking entertainment environment implemented in accordance with an embodiment. In FIG. 13A, multiple home units 20 are illustrated, each of which has an associated entertainment environment 1320-1321. The home units 20 represent a collection of home units that are sold throughout the United States and/or outside of United States to various independent individuals, businesses and the like. In one example, one or more cloud-based computing services 1302, workstations 1309, and/or enterprise servers 1303 may be established in connection with an install base of home units 20. The region 1304 generally denotes the Internet or Cloud. The cloud computing services 1302 and/or enterprise server 1303 perform all or any portion of the storage, user configuration and analysis functions described herein in connection with various embodiments. The storage, user configuration and analysis functions described herein may be divided between multiple servers, workstations, home units and the like.

By way of example, the network illustrated in FIG. 13A may represent a metropolitan area or geographic region in which home units 20 and the SD application are provided. The metropolitan area or geographic area is serviced by one or more cloud computing services 1302 and/or enterprise server 1303. Optionally, the home units 20 may be located within different zones of a single residence or business.

The cloud computing services 1302 and/or enterprise server 1303 communicate with one or more data storages 1306 that record various information that is utilized in connection with implementing embodiments herein. It is understood that the data storages 1306 are not limited to any particular structure, but instead merely refer to memories that are accessible from the internet and may store the various information described herein and that are searchable for the functions described herein. The data storage 1306 stores catalogues 1321 of IR codes for any known type/model of RCD, user profiles 1311, viewing traits 1315, and the like. The data storage 1306 stores records 1308 that may include, among other things, user configurations 1310, program guides 1319, and other information specific to individual home units and users. In addition, the data storage 1306 may store records 1308 that include universal or general template information 1317 (e.g., a universal set up template for a user interface, commonly used macros or functional sequences, and the like). The universal or general template information 1317 may be accessed by individuals (e.g., do-it-yourself) when setting up a new home unit 20, or may be used by service/installation professionals, such as in connection with installation of home units 20. A separate record 1308 may be maintained in connection with each home unit 20. The record 1308 includes, among other things, customized user configurations 1310 that have been defined by users in connection with use of the corresponding home unit 20.

In the example of FIG. 13A, a home unit #1 communicates simultaneously or at different times with smart devices SD1-SD3. Home unit #2 communicates with SD4-5, while home unit #3 communicates with SD6. The network 1300 saves, in data storage 1306, user configurations associated with SD1-SD6. As an example, SD1 and SD2 pair with HU1 at different times and utilize a common user configuration, while SD3 pairs with HU6 and uses a separate unique user configuration. Each user configuration is stored in the cloud, associated with a unique MAC address, or username and password (for the related HU) and a unique ID associated with the SD of the corresponding user.

During operation, when a particular smart device, such as SD2 pairs with the home unit HU1, the SD2 determines whether the SD2 has, saved therein, a user configuration associated with HU2. If not, the SD2 or HU1 access the cloud, provide the HU1 and SD2 unique IDs and request a corresponding user configuration. The cloud computer services 1302 accesses the associated data storage 1306 based on the HU and SD IDs and returns the corresponding user configuration, and optionally other information such as viewing profile and the program guide. The returned user configuration, program guide, etc. are uploaded to the SD2.

A similar pairing operation is performed in connection with each SD when the SEEC APP is activated within range of a home unit. When an SD moves from one entertainment environment to another entertainment environment, the SD pairs with a corresponding home unit when the SEEC APP is activated. For example, if SD2 moves from the environment 1320 associated with home unit #1 to the environment 1321 associated with home unit #2 (as denoted by the dashed lines in FIG. 12), and the user opens the SEEC APP, a new pairing and user configuration download operation occurs. When SD2 moves to the environment 1321 supported by HU2, the SD2 and/or HU2 requests the user configuration information associated with HU2. If more than one user configuration exists in connection with HU2 (and environment 1321), the cloud computing services 1302 and/or server 1303 may query the SD2 user to select one of the user configurations. If only one user configuration exists for environment 1321, the server downloads the single user configuration to SD2.

Each SD may maintain a current user configuration until the user configuration is replaced with a new user configuration. When an SD moves outside of an entertainment environment, the SD maintains the last or most recently downloaded user configuration. An SD only uploads a new user configuration when entering a new environment 1320-1322.

Optionally, an SD may store multiple user configurations, but only activate one user configuration at a time. In this example, the SD would maintain a limited local data storage, similar to data storage 1306, having a subset of user configurations for entertainment environments in which the SD has paired with HUs. Optionally, the HU may include a data storage storing multiple user configurations for the HU, as well as for entertainment environments associated with other HUs.

FIG. 13B illustrates a method for the network 1300 of FIG. 13A to manage user configurations for smart handheld devices that communicate through home units to corresponding entertainment environments. At 1350, the method waits for a SEEC APP to be activated. If a SEEC APP has not yet been loaded onto the SD, then the method provides the SEEC APP to be loaded by smart handheld devices (SDs), where the SEEC APP enables the SDs to communicate remote control (RC) commands to corresponding home units that transmit IR codes to remotely controlled (RC) devices based on the RC commands.

At 1352, upon activation of the SEEC APP, the SD begins to search for advertisements on the advertising channels from an HU. When an advertisement is found, at 1354, the SD and HU pair with one another as explained herein or in accordance with existing networking protocols. As explained above, the data storage 1306 maintain customized user configurations each associated with a corresponding home unit, the user configurations being set up by users based on individual user preferences. As explained in connection with FIG. 12, the user configurations comprise, among other things, a set of input indicia associated with a select RCD, at least a portion of the input indicia indicative of commands for the RCD; RC commands associated with the input indicia wherein the RC commands identify IR codes to be transmitted from the home unit to the RCD to instruct the RCD to perform one or more associated actions; and a user-designated presentation of the input indicia on the user interface of the SD.

At 1354, when a first SD pairs with a first home unit, the SD and/or HU determine whether the first SD has, stored therein, a first user configuration (UC) associated with the first home unit. When the first SD includes the first UC, flow moves along 1355 to 1362 where the UC is used until the SEEC APP is closed or times out.

At 1354, when the first SD does not include the corresponding UC for the first HU, flow moves to 1356. At 1356, the SD or HU sends a request for the first UC to an appropriate destination. For example, when the UCs are saved on the Cloud or an enterprise server, the request is sent to server 1303 and/or CCS 1302. The request may include a unique ID for the requesting SD and the HU (e.g., the HU MAC address).

At 1358, the method determines whether the server 1303 and/or CCS 1302 returns a UC corresponding to the HU. When a UC for the requesting HU does not exist, flow moves along branch 1357 to 1360. At 1360, the method loads the first SD with the first user configuration associated with the first home unit based on the determining operation. When a UC does not exist for the HU, flow moves along branch 1359 to 1362.

At 1362, the method enters a programming mode to permit the user to create a new user configuration associated with the associated HU and the SD. At 1364, once the new UC is created, the method forwards the UC, and HU MAC address and SD ID, to the data storage for indexing and storage. Following 1364, 1360 and 1362, the method returns to the initial point where the method waits for the user to re-activate the SEEC APP.

In accordance with embodiments for FIGS. 13A-13B, the method further comprises, when the first SD moves to an entertainment environment associated with a second home unit and pairs with the second home unit, determining whether the first SD has, stored therein, a second user configuration associated with the second home unit; and loading the first SD with the second user configuration associated with the second home unit based on the determining operation. In accordance with embodiments for FIGS. 13A-13B, the method further comprises storing the user configurations in a data storage in the Cloud and uniquely associating each of the user configurations with a MAC address of a corresponding home unit, requesting one of the user configurations based on the MAC address of the corresponding home unit. In accordance with embodiments for FIGS. 13A-13B, the method further comprises replacing the first user configuration with a new configuration each time the first SD moves to an entertainment environment associated with a new home unit and pairs with the new home unit. In accordance with embodiments for FIGS. 13A-13B, the loading operation is skipped when the determining operation determines that the first SD already has stored therein the first user configuration associated with the first home unit. In accordance with embodiments for FIGS. 13A-13B, the method further comprises, during setup, creating a plurality of first user configurations associated with the first home unit, each of the plurality of first user configurations associated with corresponding SDs from an equal plurality of SDs. In accordance with embodiments for FIGS. 13A-13B, the method comprises, during set up, entering a separate user interface for each of a plurality of different RCDs within the environment; and affording the user the option to customize the presentation of the input indicia displayed on the plurality of SDs in connection with each of the RCDs. The user-designated presentation may include a user designated combination and arrangement of the input indicia. The input indicia may include button specific commands and the first user configuration includes, for the button specific commands, at least two of button name, button type, color, IR code to be transmitted when the button is selected, button shape and location on the SD virtual grid, and one or more macros to be implemented when the button is activated. Separate user configurations may be set up for different members of a household, left-handed people, or right-handed people. Multiple user configurations may be recorded in connection with a single home unit, each user configuration may be associated with a particular smart phone.

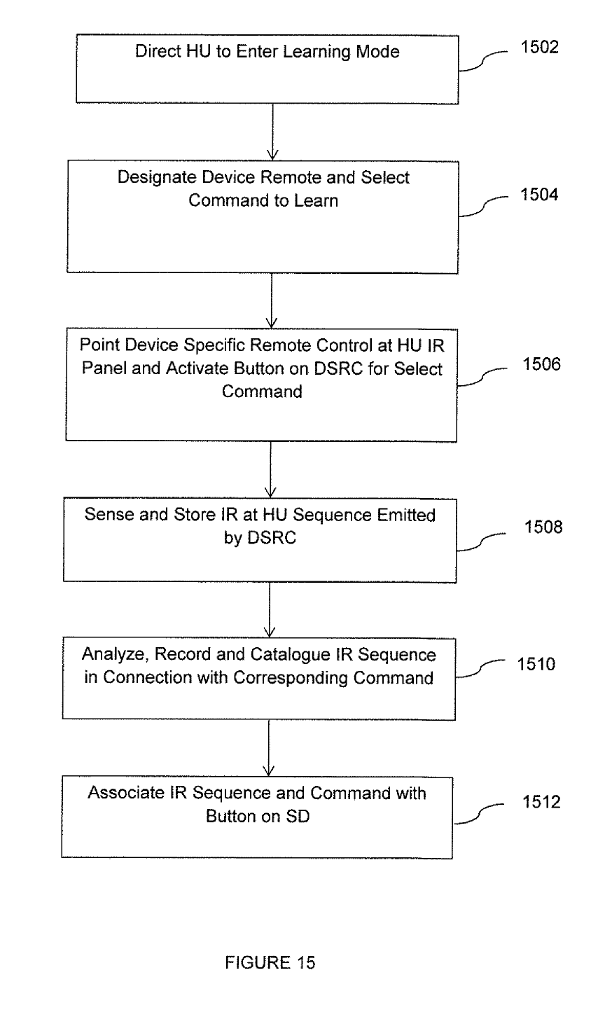

FIG. 15 illustrates a process implemented in accordance with an embodiment to learn unknown new IR sequences in connection with select commands. In certain environments, a particular remote control device may have commands associated there with, for which the IR sequences or codes are unknown. For example, the remote control device may be a very new type of TV, stereo, cable box and the like. For example, the remote control device may be relatively old and the IR codes associated there with may not be readily available in known data storages. In these and other scenarios, it may be desirable for the home unit to learn additional IR sequences or codes.

Beginning at 1502, the user direction the home unit to enter a learning mode. At 1504, the user designates the device to which the new code will apply, as well as the type, name and the like for the command associated with the new code. For example, the user may indicate that the new code is to instruct the particular model of television to switch its input source to a select input.

At 1506, the user points the device specific remote control (DSR C) at the home unit IR panel. The user presses or otherwise activates the button on the DS RC that corresponds to the select command. Optionally, the user may press a series of buttons or commands to be associated with a single select command. For example, during the learning mode, the user may turn on the television, change the input to HDMI three, adjust the volume to a desired level, as well as additional operations, all to be associated with a single command.

At 1508, the home unit senses the infrared sequence or sequences emitted by the DS RC. The home unit stores the infrared sequence or sequences in memory.

At 1510, the home unit analyzes the infrared sequence that was sentenced to identify characteristic information about the IR code therein. The home unit records the IR code that was identified locally in the home unit memory. When saving the IR code, the home unit links DIR code to the corresponding select command. Optionally, the home unit may catalog the IR code and command with a larger group of IR codes/commands. Optionally, the home unit may transmit the IR code and command remotely over a network, such as the Internet or cloud for storage and use with other home units.

At 1512, the user designates a button to be associated with the newly learned IR code and command. The home unit adds the IR code and command with an associated button to the user configuration of the SD currently paired with the home unit. Optionally, the SD may also add the IR code and command and associated button to the user configuration saved on the SD.

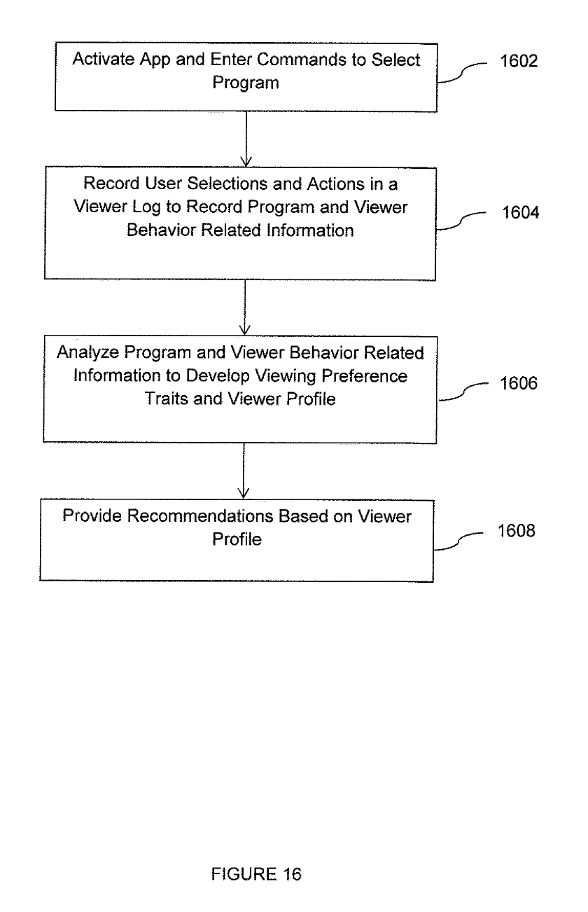

FIG. 16 illustrates a method for collecting viewer behavior information, developing viewer profiles and providing recommendations based on the viewer profile. Beginning at 1602, the user activates the SEEC APP on the SD 10 and enters a series of commands sufficient to select a program for listening and/or viewing.

At 1604, the method records the user's selection in a local data storage maintained on the SD 10 and/or HU 20. For example, the method may open a viewer log to viewer behavior related information. The viewer behavior related information includes program related information such as, the program name, service provider, program type, genre, actor, director, and the like. The viewer behavior related information includes when the user begins to watch the program, stops watching the program, whether the user changes channels during the program, how long the user watches the program, how frequently the user watches/listens to the program (e.g., for series type programs), how often the user watches similar programs, whether the user records the program, and other behavior related actions of the user. The viewer behavior related information may also include information indicating an amount of attention the user affords to the program, such as whether the user performs other functions on his/her phone during the program. When a user performs other functions (e.g. checks email, holds a phone call, performs text messaging) during a program, this may indicate a lower or medium level of interest in the program. Upon completion of a program, the method stores the viewer log in one or more locations. For example, the viewer log may be stored locally on the home unit, on the SD, and/or uploaded to a network server (in the cloud or elsewhere).

At 1606, once the user completes listening/watching the program (or stops in the program prematurely), the method analyzes the viewer behavior related information. The analysis at 1606 may occur in near real time shortly after the user stops watching/listening to the program. Alternatively or in addition, the analysis at 1606 may occur at a later time. The analysis at 1606 may be performed by the SD, the home unit, by a remote server, a cloud based analytic module or elsewhere.

The analysis at 1606 studies the viewer's behavior based on the viewer related information and the program related information to develop viewing preference traits. For example, the analysis at 1606 may seek to identify program traits that are common to recent programs viewed/listened to by the user. The traits may include genre, actor, director, year, and the like. The traits may be weighted based on a number or percentage of past programs that satisfy the particular trait. For example, when the programs viewed are distributed between action, westerns, war movies or other genre, but 90% of the programs viewed star John Wayne, the actor trait may be weighted more heavily relative to the genre trait which may be weighted less heavily. The common traits are grouped, ranked and stored for form a corresponding viewer profile. In the event that an individual already has a viewer profile, then each time a new program is viewed, the viewer profile is updated with the new viewer trait information.

At 1608, the next time the user activates the SEEC APP on the SD 10, the method may provide one or more recommendations for potential programs of interest based on the viewer profile. As one example, the recommendation(s) may be provided automatically upon activation of the app. Alternatively, the method may first receive a selection from the user and then provide more recommendations based on the current selection and the viewer profile. For example, if the user enters an indication of a desire to watch an action movie, the method may access a viewer profile associated with the user and action movies to provide recommendations for action movies that meet the viewer profile.

The methods described herein may implement various techniques for analyzing the program information and viewing behavior related information, including but not limited to the techniques described in US Patent App. Pub. 2013/0061259 A1, titled Dynamic user interface rendering based on usage analytics data in a media content distribution system; US Patent App. Pub. 2013/006912 A1, titled Streaming-Content Analytics; U.S. Pat. No. 8,549,550 B2, titled Method and apparatus for passively monitoring online video viewing and viewer behavior; US Patent App. Pub. 2012/0304209 A1, titled System and method to increase efficiency and speed of analytics report generation in audience measurement systems; U.S. Pat. No. 8,577,996 B2, titled Method and apparatus for tracing users of online video web sites; U.S. Pat. No. 8,457,475 B2, titled Systems and methods for interactive program guides with personal video recording features; and US Patent App. Pub. 2013/0014137 A1, titled User impression media analytics platform apparatuses and systems, all of which the complete subject matter is expressly incorporated herein by reference in their entireties.

### TERMINOLOGY

The terms “IR code”, and “IR pulse sequence” are used interchangeably throughout.

The terms “cloud” or “cloud computing” represent a model for delivering information technology services in which resources are retrieved from the Internet through web-based tools and applications, rather than a direct connection to a server and in which data and software packages are stored in one or more servers interconnected over the Internet.

The terms “redirect”, “redirective”, “reflect” “reflective” and similar terms refer to changes in direction of a signal upon contacting objects within an area of transmission.

The terms “audio/video” and “A/V” are not limited to content or devices that include both audio and video, but instead shall mean any audio only device, combined audio and video device, video only device, any audio only content, combined audio and video content, and video only content.

The terms “record” and “file” are not limited to any particular data structure, but instead generally refer to any form of managed interconnection between various data items, such as a unique identifier (e.g. Mac address) and a collection of data items (e.g., user configurations, program directories, Macros, etc.).

The term “customize”, when used in connection with user configurations, is used to indicate that a user provides at least limited input into the content of the user configuration. It is understood that a majority of the user configuration may be common or generic to numerous user configurations.

The term “audio/visual equipment” is used throughout this disclosure, and is intended to describe any audio and/or visual equipment for delivering audio and/or visual images to a user. Such equipment may include, merely by way of example, a television, image projection device, stereo, audio and/or visual receiver, satellite television receiver, cable television receiver, digital video recorder, digital video disc (DVD) player/recorder, Blue-ray™ Disc player/recorder, video cassette player/recorder, entertainment device, multimedia or other computer, streaming media device, multimedia or other tablet, multimedia or other handheld device, multimedia or other personal data assistant, and/or multimedia or other mobile phone.

The transmitter may include any device that transmits signals remotely to audio/visual equipment. Merely by way of example, such transmitters may include RF transmission antennas/devices, infrared transmission devices, and/or any other non-wired data transmission device. The transmitter may transmit data representative of user input received by the input device, such that the audio/video equipment may act on such directions when received.

The transmitter may include any device that transmits signals remotely to audio/visual equipment. Merely by way of example, such transmitters may include RF transmission antennas/devices, infrared transmission devices, and/or any other non-wired data transmission device. The transmitter may transmit data representative of user input received by the input device, such that the audio/video equipment may act on such directions when received.

While the embodiments described herein refer to the BlueTooth and WiFi networks and protocols, it is understood that any network or protocol may be used therein including, but not limited to, 802.11a/b/g/n (WiFi); IEEE 1901, 1905 (Power line Networks); SONET; as well as Device to Device networks such as Wireless USB; Zigbee; Bluetooth; Wireless HD; as well as Mobile Networks such as LTE, GSM, HSPA, 2G/3G/4G and the like.

While the embodiments described herein relate to remote control of audio and/or video devices, optionally the HUs, SDs, and SEEC APPs described herein may be used to describe any device that is remotely controllable through an IR pulse sequence. For example, the RC devices may include home appliances, heating and ventilation air conditioning systems, home security systems, door locks, window locks and the like.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the embodiments, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112(f) unless and until such claim limitations expressly use the phrase “means for” followed by a statement of function void of further structure.

What is claimed is:

1. A remote control and streaming interface for an entertainment environment, the system comprising:
an infrared (IR) transmitter panel holding an optical IR transmitter;
at least one transceiver configured to maintain a bidirectional administration link with a smart handheld device and configured to maintain a separate streaming link with the smart handheld device (SD);
a processor configured to identify remote control (RC) commands received over the administration link, the processor configured to direct the optical IR transmitter to generate an IR signal having a select IR pulse sequence based on the RC commands;
the optical IR transmitter configured to transmit the IR signal in a reflective-deflective pattern across the entertainment environment until reaching at least one remotely controlled (RC) device within the entertainment environment, wherein the RC device is positioned in a non-line of sight relation with the optical IR transmitter.

2. The system of claim 1, further comprising a streaming and entertainment environment control application (SEEC APP) to be loaded by the SD, the SEEC APP enabling the SD to communicate the RC commands to the processor that directs the optical IR transmitter to transmit the IR pulse sequences to RC devices based on the RC commands.

3. The system of claim 2, wherein the SEEC APP maintains, on the SD, a customized user configuration associated with the corresponding entertainment environment, the user configuration being set up by a user through the SEEC APP based on individual user preferences, the user configuration comprising:
a set of input indicia associated with a select RC device, at least a portion of the input indicia indicative of commands for the select RC device,
RC commands associated with the input indicia wherein the RC commands identify IR pulse sequences to be transmitted from the optical IR transmitter to the RC device to instruct the RC device to perform one or more associated actions; and
a user-designated presentation of the input indicia on the user interface of the SD.

4. The system of claim 2, further comprising:
an IR sensor configured to sense IR signals, wherein the SEEC APP is configured to learn RC commands for a select RC device, when in a learn mode, by;
i) sensing, at the IR sensor, a new IR pulse sequence that is generated by a handheld remote control that is associated with the select RC device;
ii) receiving an input indicating a new RC command; and
iii) storing the new IR pulse sequence with the new RC command.

5. The system of claim 1, further comprising an audio output component configured to generate an audio signal, the processor configured to identify audio data received over the streaming link, the processor configured to direct the audio output component to generate the audio signal based on the audio data.

6. The system of claim 1, wherein the IR signals are configured to reflect off objects in the entertainment environment in multiple directions.

7. The system of claim 1, wherein the optical IR transmitter comprises a plurality of LEDs arranged in a two dimensional array on the IR transmitter panel.

8. The system of claim 1, wherein the optical IR transmitter includes first and second LEDs having corresponding different first and second propagation directions and different first and second propagation envelopes, respectively.

9. The system of claim 5, wherein the first propagation envelope has a narrow beamwidth and the second propagation envelope has a wide beamwidth relative to the narrow beamwidth.

10. The system of claim 5, wherein the first and second propagation directions project at different first and second angles from a front surface of the IR transmitter panel such that the first and second IR LEDs transmit IR signals having a common IR code from the IR transmitter panel at the different first and second angles.

11. The system of claim 1, wherein the transceiver is configured to establish a temporary low energy administration link between the home unit and at least one smart handheld device in connection with conveying remote control related command(s) to the home unit.

12. The system of claim 1, wherein the transceiver is configured to communicate with the smart handheld device using a Bluetooth Low Energy (BLE) communications protocol, in connection with the bidirectional administrative link, to remotely control one or more NV remotely controllable devices.

13. The system of claim 1, wherein the optical IR transmitter includes an LED array that is arranged such that the IR signals propagate in multiple directions and at multiple angles from the LED array, the IR signals contacting other structures within the entertainment environment and be redirected or reflected in other directions such that the IR signals bounce off multiple structures in the entertainment environment before reaching the RC device, wherein redirection/reflection of the IR signals increases a likelihood that one or more of the IR signals is received by each of the RC device.

14. A method for providing a remote control and streaming interface for an entertainment environment, the method comprising:
defining a bidirectional administration link and a separate streaming link to be maintained between a smart handheld device (SD) and a home unit (HU) located in the entertainment environment;
identifying remote control (RC) commands received over the administration link by the HU from the SD;
generating an IR signal having a select IR pulse sequence based on the RC commands; and
transmitting the IR signal in a reflective-deflective pattern across the entertainment environment until reaching at least one remotely controlled (RC) device within the entertainment environment, wherein the RC device is positioned in a non-line of sight relation with the optical IR transmitter.

15. The method of claim 14, further comprising providing a streaming and entertainment environment control application (SEEC APP) to be loaded by the SD, the SEEC APP enabling the SD to communicate the RC commands to the HU that directs transmission of the IR pulse sequences to RC devices based on the RC commands.

16. The method of claim 15, further comprising maintaining, through the SEEC APP, a customized user configuration associated with the corresponding entertainment environment, the user configuration being set up by a user through the SEEC APP based on individual user preferences, the user configuration comprising:
a set of input indicia associated with a select RC device, at least a portion of the input indicia indicative of commands for the select RC device,
RC commands associated with the input indicia wherein the RC commands identify IR pulse sequences to be transmitted to the select RC device to instruct the select RC device to perform one or more associated actions; and
a user-designated presentation of the input indicia on the user interface of the SD.

17. The method of claim 15, further comprising:
directing the SEEC APP to enter a learn mode to learn RC commands for a select RC device;
sensing a new IR pulse sequence that is generated by a handheld remote control that is associated with the select RC device;
receiving an input indicating a new RC command; and
storing the new IR pulse sequence with the new RC command.

18. The method of claim 14, further comprising identifying audio data received over the streaming link; directing an audio output component to generate an audio signal based on the audio data.

19. The method of claim 14, wherein the IR signals reflect off objects in the entertainment environment in multiple directions.

20. The method of claim 14, further comprising transmitting the IR pulse sequence in different first and second propagation directions and with different first and second propagation envelopes.

21. The method of claim 20, wherein the first propagation envelope has a narrow beamwidth and the second propagation envelope has a wide beamwidth relative to the narrow beamwidth.

22. The method of claim 20, wherein the first and second propagation directions project at different first and second angles such that first and second IR LEDs transmit IR signals having a common IR pulse sequence at the different first and second angles.

23. The method of claim 14, further comprising establishing a temporary low energy administration link between the home unit and at least one smart handheld device in connection with conveying remote control related command(s) to the home unit.

24. The method of claim 14, further comprising using a Bluetooth Low Energy (BLE) communications protocol, in connection with the bidirectional administrative link, to remotely control one or more remotely controllable devices.

25. A method for managing user configurations for smart handheld devices that communicate through home units to corresponding entertainment environments, the method comprising:
providing a streaming and entertainment environment control application (SEEC APP) to be loaded by smart handheld devices (SDs), the SEEC APP enabling the SDs to communicate remote control (RC) commands to corresponding home units that transmit IR codes to remotely controlled (RC) devices based on the RC commands;
maintaining customized user configurations each associated with a corresponding home unit, the user configurations being set up by users based on individual user preferences, the user configurations comprising:
a set of input indicia associated with a select RCD, at least a portion of the input indicia indicative of commands for the RCD,
RC commands associated with the input indicia wherein the RC commands identify IR codes to be transmitted from the home unit to the RCD to instruct the RCD to perform one or more associated actions; and
a user-designated presentation of the input indicia on the user interface of the SD; and
when a first SD pairs with a first home unit, determining whether the first SD has, stored therein, a first user configuration associated with the first home unit;
loading the first SD with the first user configuration associated with the first home unit based on the determining operation.

26. The method of claim 25, further comprising: when the first SD moves to an entertainment environment associated with a second home unit and pairs with the second home unit, determining whether the first SD has, stored therein, a second user configuration associated with the second home unit; and loading the first SD with the second user configuration associated with the second home unit based on the determining operation.

27. The method of claim 25, further comprising storing the user configurations in a data storage in the Cloud and uniquely associating each of the user configurations with a MAC address of a corresponding home unit, requesting one of the user configurations based on the MAC address of the corresponding home unit.

28. The method of claim 25, further comprising replacing the first user configuration with a new configuration each time the first SD moves to an entertainment environment associated with a new home unit and pairs with the new home unit.

29. The method of claim 25, wherein the loading operation is skipped when the determining operation determines that the first SD already has stored therein the first user configuration associated with the first home unit.

30. The method of claim 25, further comprising, during setup, creating a plurality of first user configurations associated with the first home unit, each of the plurality of first user configurations associated with corresponding SDs from an equal plurality of SDs.

31. The method of claim 25, during set up, entering a separate user interface for each of a plurality of different RCDs within the environment; and affording the user the option to customize the presentation of the input indicia displayed on the plurality of SDs in connection with each of the RCDs.

32. The method of claim 25, wherein the user-designated presentation includes a user designated combination and arrangement of the input indicia.

33. The method of claim 25, wherein the input indicia include button specific commands and the first user configuration includes, for the button specific commands, at least two of button name, button type, color, IR code to be transmitted when the button is selected, button shape and location on the SD virtual grid, and one or more macros to be implemented when the button is activated.

34. The method of claim 25, wherein multiple user configurations are recorded in connection with a single home unit, each user configuration may be associated with a particular SD.

35. A method for learning remote control (RC) commands for a streaming and entertainment control interface that enables a smart handheld device to communicate through a home unit (HU) with remotely controlled (RC) devices in a corresponding entertainment environment, the method comprising:
providing a streaming and entertainment environment control application (SEEC APP) to be loaded by the smart handheld device (SD), the SEEC APP enabling the SD to communicate remote control (RC) commands to the corresponding home unit that transmits IR pulse sequences to RC devices based on the RC commands;
directing the SEEC APP to enter a learn mode to learn RC commands for a select RC device;
sensing, at an IR sensor, a new IR pulse sequence that is generated by a handheld remote control that is associated with the select RC device;
receive an input indicating a new RC command; and
store the new IR pulse sequence with the new RC command.

36. The method of claim 35, configuring the SEEC APP to enable a user to designate the new RC device through a user interface of the SD.

37. The method of claim 35, pointing an IR transmitter of the remote control at the IR sensor and activating a button on the remote control that corresponds to the new RC command such that the IR sensor senses the new IR pulse sequence generated by the remote control when the button is activated.

38. The method of claim 35, storing the new IR pulse sequence and RC command in memory of the at least one of the SD and HU.

39. The method of claim 35, associating the new IR pulse sequence and RC command with a input indicia in an input window of the SEEC APP on the SD.

40. A method for collecting viewer behavior information through a streaming and entertainment control interface that enables a smart handheld device to remotely control (RC) RC devices in a corresponding entertainment environment, the method comprising:
providing a streaming and entertainment environment control application (SEEC APP) to be loaded by the smart handheld device (SD), the SEEC APP enabling the SD to communicate remote control (RC) commands to the RC devices;
recording user selections and actions on the SD, in connection with entering RC commands, into a viewer log as program and viewer behavior related information;
analyzing the program and viewer behavior related information to develop viewing preference traits; and
recording the viewing preference traits in a viewer profile.

41. The method of claim 40, wherein the program and viewer behavior related information includes at least one of program name, service provider, program type, genre, actor, director, when the user begins to watch a program, stops watching the program, whether the user changes channels during the program, how long the user watches the program, how frequently the user watches/listens to the program, how often the user watches similar programs, whether the user records the program, and other behavior related actions of the user

42. The method of claim 40, wherein the viewer behavior related information includes an indicating of an amount of attention the user affords to a program, including at least one of whether the user performs other non-program related functions on the SD during the program, the non-program related functions including at least one of checking email, holding a phone call, text messaging.

43. The method of claim 40, further comprising providing recommendations for programs to the user based on the viewer profile.
